(19) United States
(12) Patent Application Publication
(10) Pub. No.: US 2013/0133903 A1
(43) Pub. Date: May 30, 2013

(54) Hole Digging Tiller Or Cultivator

(71) Applicant: John M. Lipscomb, Cedarburg, WI (US)

(72) Inventor: John M. Lipscomb, Cedarburg, WI (US)

(21) Appl. No.: 13/816,564

(22) PCT Filed: May 16, 2012
(86) PCT No.: PCT/US12/38226

§ 371 Date: Feb. 12, 2013

Related U.S. Application Data
(60) Provisional application No. 61/486,452, filed on May 16, 2011.

(51) Int. Cl. A01B 33/16; A01B 33/02; A01C 5/04

(52) U.S. Cl. CPC A01B 33/16; A01C 5/04; A01B 33/028
USPC 172/1; 172/42

(57) ABSTRACT

A hole digger having an anchor inserted into the ground so tines rotate in place discharging loose material from a hole being dug. The anchor includes an elongate stake carried by the transmission carrying the tines that is inserted to a depth greater than tine depth limiting tine travel to an arc about the stake. The digger can include one or more digger tines of increased axial surface area provided by an axial deflector extending radially along part of a tine facing toward the outer edge of the hole increasing the volume discharged from the hole during each tine rotation. Such a digger can be produced by modifying a garden tiller or cultivator to include an anchor mounted to its transmission and can further include one or more digger tines if desired. The anchor and deflectors can form a kit for retrofitting a tiller or cultivator into a hole digger.

### FIELD

The present invention relates to hole diggers and more particularly to a cultivator or tiller configured to dig a hole and a method of operating such a hole digging cultivator or tiller to dig a hole.

### BACKGROUND

Many attempts have been made in the past to automate the process of digging a hole such as for planting a tree, bush, plant or the like. Such hole digging arrangements typically employ a rotary auger connected to a prime mover, such as an internal combustion engine, which drives an auger shaft carrying one or more auger flights that are typically helical. In use, the free end of the rotating auger is brought into contact with the ground with the auger corkscrewing into the ground simultaneously propelling dirt, turf and the like upwardly creating a hole in which a roots of a tree, bush, plant or the like can be placed. While hole digging augers have enjoyed substantial commercial success, they are extremely specialized as they typically can only be used to bore a hole in the ground. In addition, they are not easy to store or use as they are unwieldy, typically being several feet in length. They are also fairly expensive such that many weekend or hobbyist gardeners are reluctant to purchase one despite having a relatively frequent need to bore a hole in the ground.

However, many of these same amateur gardeners and hobbyists have a tiller at their disposal. Tillers, also known as garden cultivators or rototillers, have a prime mover, such as an electric motor or internal combustion engine, which rotates a plurality of sets of tines about an axis of rotation that is generally transverse or generally perpendicular to the direction the tiller moves during operation. Such tillers are typically of walk-behind construction having either rotary tines located in front of the tiller that help pull the tiller forward when they rotate during tiller operation or rotary tines located in the rear of the tiller that help push the tiller forward when they rotate during tiller operation.

During operation, a person manually using the tiller grasps its handles walking with the tiller as its tines rotate engaging the ground breaking up the soil. As the rotating tines engage the ground and break up the soil, weeds are dislodged while the soil is aerated. As the rotating tines engage the ground, they also help propel the tiller forwardly causing a desired length of the ground to become tilled or cultivated. Some tillers have a drag stake or drag bar rearwardly of the rotary tines that hangs downwardly between the user and the rotary tines to engage the ground to prevent the tiller from “crabbing” or walking so fast that the ground is inadequately broken by the rotary tines. Other types of tillers, such as mini tillers, often lack any such drag stake or drag bar.

While walk behind tillers and garden cultivators have enjoyed considerable commercial success, they are unsuitable for hole digging.

### SUMMARY

The present invention is directed to a hole digger that can be configured from a walk behind garden cultivator or tiller modified to include a hole digger anchor that keeps the hole digger anchored in the ground in one place where a hole is desired enabling rotating tines to break up the ground and propel the broken up ground outwardly away from the anchor producing a hole. Such a hole digger can include one or more rotary tines having an angled outer deflector that deflects an increased volume of broken up ground outwardly from the hole during hole digging. One preferred hole digger constructed in accordance with the present invention has a hole digger anchor disposed interjacent a pair of outer tine sets each having one or more tines equipped with generally radially extending axial outer deflectors that scoop up and propel ground broken up by the rotating tines out of the hole being dug by the hole digger.

A hole digger constructed in accordance with the present invention includes a downwardly extending hole digger anchor disposed adjacent a plurality of sets of rotary tines that is inserted downwardly into the ground where a hole is desired preventing fore or aft travel of the hole digger in a substantially straight line direction when the tines are rotated during hole digging. The hole digger anchor includes an elongate hole digger anchor stake having a length enabling the stake to extend below a radial depth in the ground reachable by the rotating tines to help more firmly anchor the hole digger substantially in place during hole digging. The anchor stake can be tapered at or adjacent its free end, including to a point, where inserted into the ground to help enable the depth of insertion of the stake to increase as the depth of the hole being dug increases. The anchor stake is disposed interjacent a pair of rotary tines that can be spaced apart by a transmission of the hole digger enabling the hole digger to be pivoted by the stake to enable rotating tines to travel in an arc or circle about the stake to remove at least an annular section of ground around the stake in digging a hole.

In one preferred hole digger embodiment, hole digger anchor is provided by an elongate anchor stake that extends downwardly from part of the transmission outwardly beyond the transmission to a depth below that which is reachable by the rotating tines during hole digging. In at least one embodiment, the anchor stake extends outwardly and downwardly from a front end or edge of the transmission and in at least one other embodiment, the anchor stake extends outwardly and downwardly from a rear end or edge of the transmission. The anchor stake can be adjustably mounted to enable the depth of insertion of the stake into the ground to be changed. Such an adjustably mounted anchor stake arrangement can also be configured to enable the stake to be raised upwardly to an out-of-the way position where the stake will not interfere with operation of the hole digger as a conventional tiller or cultivator. The anchor stake also can be removably mounted to enable removal of the stake when it is desired to operate the hole digger as a conventional tiller or cultivator.

The hole digger has a plurality of sets of rotary tines with at least one set of tines carried by a segment of a shaft extending generally perpendicularly outwardly from the transmission in one direction and at least one set of carried by another substantially coaxial shaft segment extending generally perpendicularly outwardly from the transmission in an opposite direction. In a preferred embodiment, an axially outermost set of tines attached to each shaft segment includes a transversely mounted deflector that acts as a scoop possessing a greater axial surface area that enables a greater volume of ground broken up by the tines to be flung out of the hole being dug. Where a tine is equipped with such a deflector, the deflector extends generally axially outwardly along a generally radially extending portion of the tine increasing the axial extent of the tine which thereby increases the axially extending surface area available to radially outwardly fling ground matter broken up during hole digging.

In one deflector embodiment, an outer surface of the deflector against which ground matter impinges during tine rotation is angled relative to the tine carrying the deflector along with the plane in which the tine substantially rotates during hole digger operation. In a preferred deflector embodiment, the outer surface of the tine is obtusely angled relative to the tine and plane in which the tine rotates so the outer deflector surface faces generally outwardly away from the tine toward part of the outer periphery of the hole being dug. Such an outwardly obtusely angled deflector preferably is mounted to the outer surface of the tine that faces outwardly toward part of the outer periphery of the hole being dug to impart momentum to broken or loose ground matter being deflected toward the outer periphery of the hole.

Such a deflector can be three dimensionally configured to accelerate broken or loose ground matter being deflected by the deflector-equipped tine so it clears the outer periphery of the hole. Such a three dimensionally configured deflector can have a bend or radius of curvature that helps the deflector scoop up and deflect a greater volume of loose or broken up ground out of the hole. In one three dimensionally configured deflector embodiment, the deflector has a bend dividing the outer deflector surface into a pair of deflector panels with one panel being disposed radially outwardly of the other panel. The panels are angled relative to one another and the tine to which the deflector is attached to direct loose or broken up ground matter impinging against a radially innermost deflector panel toward a radially outermost deflector panel in a manner that increases the momentum tending to propel the deflected ground matter completely out of the hole.

In a method of digging a hole, an anchor stake of the hole digger anchor is inserted into the ground at a center location where a hole is desired to be dug. The rotating tines of the hole digger engage the ground breaking up and loosening ground matter before it is propelled radially outwardly from the hole. A user manipulates the hole digger so it pivots about the anchor stake without moving in a straight line causing the rotating tines to break up and loosen ground matter in the hole in an arc traveled by the tines that extends about the stake producing a hole that is generally circular. The user can pivot the hole digger back and forth about the stake a plurality of times to cause the rotating tines to travel at least about 90 degrees about the stake and as much as 360 degrees about the stake to produce a generally round hole of a suitable depth.

In one preferred embodiment, a hole digger constructed in accordance with the present invention can be configured to function solely as a hole digger, can be configured to convert between functioning as hole digger and a conventional walk behind garden cultivator or tiller, and can be made by converting a conventional walk behind garden cultivator or tiller by retrofitting the cultivator or tiller with a hole digger anchor. Such a hole digger preferably also has a plurality of tines configured for hole digging by providing a greater axial extent or surface area to propel a greater volume of broken up or loose ground matter out of the hole. Such hole digging tines can be manufactured for hole digging or can be produced by modifying conventional tiller or cultivator tines in a manner that increases their axial extent or axial surface area during tine rotation during hole digging. Where conventional tiller or cultivator tines are modified into hole digging tines, one or more deflectors attachable to conventional cultivator or tiller tines can be provided as part of a retrofit kit or package that can include a hole digger anchor and other hardware.

### DRAWING DESCRIPTION

One or more preferred exemplary embodiments of the invention are illustrated in the accompanying drawings in which like reference numerals represent like parts throughout and in which:

FIG. 1 illustrates a perspective view of an embodiment of a hole digging tiller or cultivator constructed in accordance with the present invention having a forwardly mounted hole digger anchor;

FIG. 2 is a side elevation view of the hole digging tiller or cultivator of FIG. 1;

FIG. 3 is an enlarged fragmentary top right side perspective view of another preferred embodiment of a hole digging tiller or cultivator constructed in accordance with the present invention having a rearwardly mounted hole digger anchor;

FIG. 4 is an enlarged left side perspective view of a preferred embodiment of a hole digger anchor assembly;

FIG. 5 is a top plan view of a preferred hole digging tine set for mounting to a rotary tine shaft of a hole digger or a tiller being converted to a hole digger;

FIG. 6 is a perspective view of the hole digging tine set of FIG. 5;

FIG. 7 is a cross sectional view of the hole digging tine set of FIG. 5 taken along lines 7-7 of FIG. 5;

FIG. 8 is a fragmentary cross sectional view of part of the hole digging tine set of FIG. 5 taken along lines 8-8 of FIG. 5;

FIG. 9 is a perspective view of a hole digging deflector that is attached to one or more tines of a hole digging tine set;

FIG. 10 is a schematic top plan view of a hole digging tiller or cultivator showing a range of hole digger anchor locations and depicting hole digging tiller or cultivator operation;

FIG. 11 is another schematic top plan view illustrating another range of hole digger anchor locations;

FIG. 12 is an enlarged side elevation view of another preferred hole digger anchor assembly having fore and aft hole digger anchors;

FIG. 13 is an enlarged side elevation view of still another preferred hole digger anchor assembly having a barbed hole digger anchor;

FIG. 14 is an enlarged side elevation view of still another preferred hole digger anchor assembly;

FIG. 15 is a front left perspective view of a further preferred hole digger anchor assembly having an adjustable hole digger anchor;

FIG. 16 is a side elevation view of the hole digger anchor assembly of FIG. 15;

FIG. 17 is a side elevation view of another preferred hole digger anchor assembly having a hole digger anchor stake that is adjustable;

FIG. 18 is a side elevation view of another preferred hole digger anchor assembly having an adjustable hole digger anchor stake;

FIG. 19 is a fragmentary top plan view of the preferred hole digger anchor assembly of FIG. 18;

FIG. 20 is a perspective view of a preferred hole digger anchor stake embodiment used with the hole digger anchor assembly shown in FIGS. 18 and 19;

FIG. 21 is a side elevation view of still another preferred hole digger anchor assembly having the mounting arrangement and hole digger anchor integrally formed as a common unit;

FIG. 22 is a top perspective view illustrating a hole dug using a hole digger constructed in accordance with the present invention;

FIG. 23 is a perspective view showing the hole digger in operation by a user with the hole digger anchor preventing the rotating tines of the hole digger from walking or crabbing in a generally horizontal direction relative to a rotational axis of the tines along the ground enabling the rotating tines to rotate in one place digging a hole in a desired location where the hole digger anchor is embedded in the ground deeper than the tines;

FIG. 24 is a fragmentary perspective view of a hole digger anchor embodiment of the hole digger shown in FIG. 23;

FIG. 25 is a perspective view depicting hole digger operation by a user in digging a hole with the straight line position of the hole digger substantially fixed in place by the hole digger anchor embedded into the ground enabling the rotating tines to travel in an arc about the embedded anchor;

FIG. 26 is another perspective view depicting operation of the hole digger by a user digging a hole illustrating that the hole digger has been rotated about the hole digger anchor in an arc in at least one rotational direction to cause the tines to orbit about the anchor an angular extent helping produce a hole that is generally round or circular;

FIG. 27 is a fragmentary perspective view of a portion of a finished hole dug by the hole digger with the rotary tines stopped and disposed within the hole; and

FIG. 28 is a fragmentary perspective view of the hole dug by the user with a leg of the user partially standing in the hole illustrating a depth of the hole dug using a hole digger constructed in accordance with the present invention.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

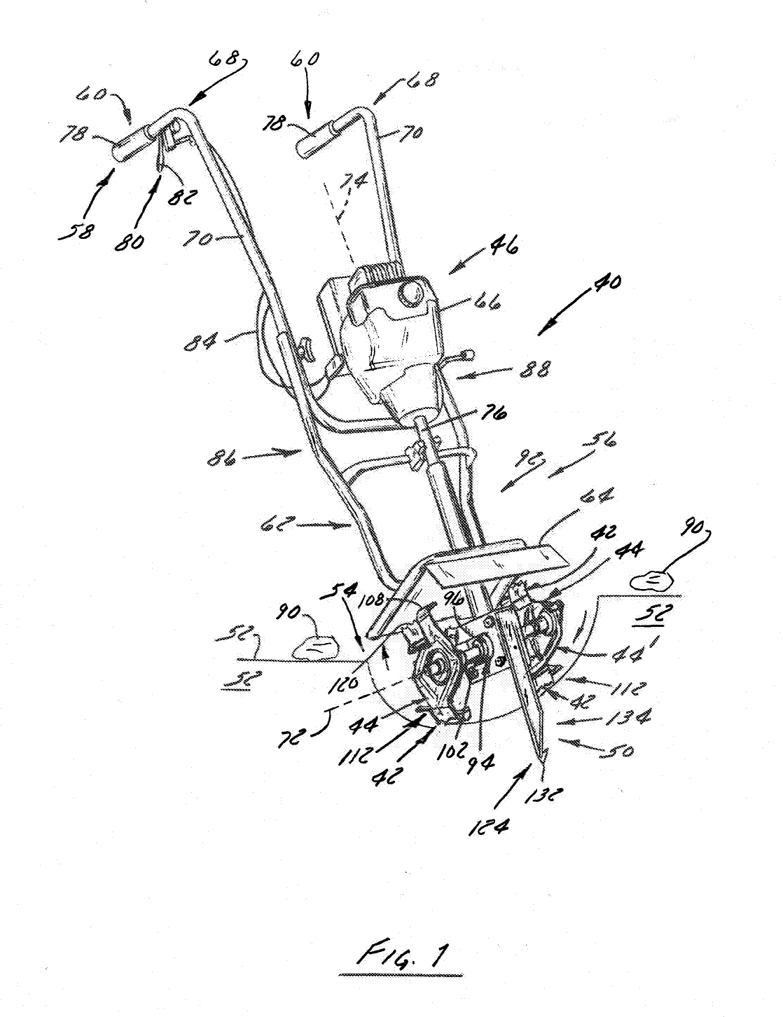

FIGS. 1-4 illustrate a hole digger 40 constructed in accordance with the present invention having a plurality of sets 42 of tiller or cultivator tines 44 rotated by a prime mover 46 about a generally horizontal rotational axis 72 that includes a hole digger anchor 50 extending downwardly from adjacent the tine sets 42 into the ground 52 anchoring the hole digger 40 in place preventing fore-aft hole digger movement during digging of a hole 54 in the ground 52. In a preferred embodiment, the hole digger 40 is a manually operated tiller or garden cultivator 56 modified to include an elongate hole digger anchor 50 that extends from adjacent the tine sets 42 outwardly a sufficient distance so the hole digger anchor 50 is inserted into the ground 52 deep enough to keep the hole digger 40 from moving fore or aft during hole digging. In a preferred embodiment, one or more tines 44′ or one or more sets 42′ of tines 44′ are modified to include one or more hole digging deflectors 112 that more efficiently propel soil, dirt, rocks, etc. out of the hole 54 speeding hole digging.

In use, the hole digger 40 is manually maneuvered to a location where a hole is desired, the digger 40 is manipulated to insert the hole digger anchor 50 into the ground 52 anchoring the digger 40 in place, and a plurality of sets 42 of tines 44 are rotated until a hole 54 of a desired depth is formed. During hole digging, the hole digger 40 can be manually pivoted about the hole digger anchor 50 while the anchor 50 is inserted into the ground 52 to cause the rotating sets 42 of tines 44 to circle around the anchor 50 displacing dirt, soil, sand, rocks, and other chunks 90 of ground 52 broken up by the rotating tines 44 in an annular region around the anchor 50 helping dig the hole 54. Where one or more tines 44′ or sets 42′ of tines 44′ are configured with one or more deflectors 112, rotation of the tines 44′ during hole digging more efficiently propels soil, dirt, rocks, stones, and other chunks 90 upwardly and outwardly away from the anchor 50 beyond the hole 54 being dug more quickly and efficiently digging the hole 54.

In one preferred hole digger embodiment, a tiller 56 can be modified to produce a hole digger 40 constructed in accordance with the prevent invention having an elongate hole digger anchor 50 that anchors the tiller 56 substantially in one place preventing fore-aft tiller motion so the rotating tines 44 can displace dirt, soil, sand, rocks, and other chunks 90 of ground 52 broken up by the rotating tines 44 away from the anchor 50 to form a hole 54. Such a hole digger modified tiller 56 can have one or more hole digging tines 44′ or sets 42′ of tines 44′ that help propel soil, dirt, rocks, stones, and other loose chunks 90 from the hole 54 during tine 44′ rotation.

A hole digger 40 constructed in accordance with the present invention can be of walk behind construction much like that of a garden cultivator or roto tiller of walk behind construction of a type typically used to break up ground, e.g., soil, dirt, sod, turf and the like, in plots, gardens and such, including to mix the ground to prepare for planting, aerate soil, eliminate weeds, and the like. The hole digger 40 is manually operated and has a manually graspable handle arrangement 58 that includes at least one handle 60 grasped during use by a hand of a person operating the hole digger 40. Each handle 60 can extend outwardly from a chassis 62 that can carry a shield or guard 64, e.g., fender guard, which overlies the plurality of sets 42 of rotary ground-engaging tines 44.

The chassis 62 also carries the prime mover 46, also known as a powerhead, which overlies the shield or guard 64. The powerhead 46 can be an internal combustion engine, such as the engine 66 shown in FIGS. 1-4, or can be an electric motor (not shown). In the embodiment shown in the drawings, the powerhead 46 is attached to part of the chassis 62 from which the handles 60 extend and can include a portion of each handle 60. The powerhead 46 can be attached to part of the chassis to which the shield or guard 64 is fixed with the shield or guard 64 being disposed between the powerhead 46 and the tines 44. In another embodiment, the shield or guard 64 can be attached directly to the powerhead 46 (or vice versa) with the powerhead 46 disposed adjacent the tines 44 with the shield or guard 64 disposed therebetween.

Each handle 60 can include a handle bar 68 formed of an elongate tube 70 extending upwardly and outwardly from the chassis 62 in a direction generally transverse to an axis of rotation 72 of the tines 44. An upwardly extending portion of each handle tube 70 can extend upwardly in a direction that is acutely angled and which can be generally parallel relative to an axis of rotation 74 of an output or drive shaft 76 of the powerhead 46. As is shown in FIGS. 1-4, where a pair of handle tubes 70 are employed, one of the handle tubes 70 can be disposed on one side of the powerhead drive shaft axis 74 and the other one of the handle tubes 70 can be disposed on the other side of the axis 74. During operation, the handle tubes 70 are typically disposed between the powerhead 46 and a user of the hole digger 40. Each handle tube 70 includes a handgrip 78 that can be integrally formed of part of the tube 70 that can be bent at an angle relative to the rest of the tube 70 toward a user of the hole digger 40. The handgrips 78 extend generally outwardly toward the user in a common direction, can be generally parallel to one another, and are configured to be of ergonomic construction that can easily be manually grasped by the user.

An operating control 80 can be mounted on or adjacent one of the handgrips 78, such as depicted in FIG. 1. Such a control 80 can include a lever 82 that can be manually squeezed during operation, such as to engage the tines 44 to cause them to rotate during hole digging. Such a control 80 can be configured to control a plurality of aspects of operation, including powerhead speed or output, e.g., throttle, choke, tine engagement/disengagement, and the like. Each such control 80 typically is coupled by a cable 84 or other type of link to a corresponding part of the hole digger 40 whose operation is impacted by user interaction with the control 80. If desired, one or both handgrips 78 can be equipped with one or more such controls.

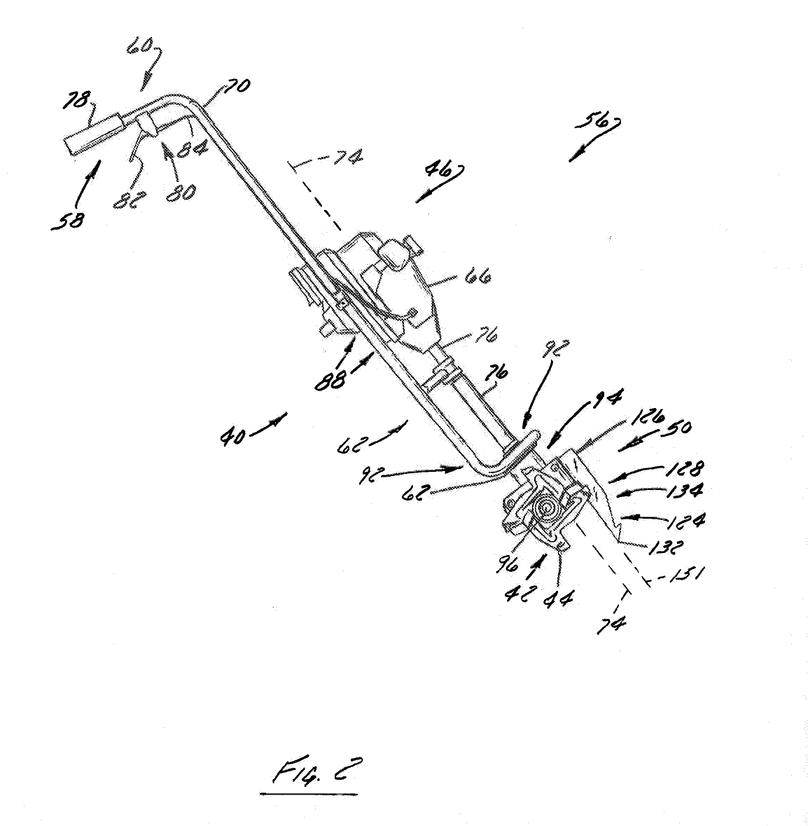

As is best shown in FIGS. 1 and 2, the chassis 62 can be formed of a tubular frame 86 from which the handles 60 upwardly and outwardly extend. The tubular frame 86 includes an upper frame 88 to which the powerhead 46 is mounted and a lower frame 92 to which the shield 64 and a rotary tine shaft support housing or transmission housing 102 is attached. While the chassis or frame shown in the drawing figures is of tubular construction, other chassis and frame configurations can be used.

Housing 102 houses a transmission 94 and rotatively supports a rotary tine shaft 96 carrying the tines 44 that rotates about a generally horizontal rotational axis 72 substantially simultaneously rotating the tines 44. The transmission 94 is disposed between a plurality of sets 42 of the tines 44 having at least one set 42 of tines disposed on one side of the transmission 94 and at least one other set 42 of tines 44 disposed on the other side of the transmission 94. The transmission 94 can be a differential or another type of rotary power transfer device which is coupled or otherwise connected to the drive shaft 76 enabling communication of rotary power from the powerhead 46 to the tines 44. Although a single drive shaft 76 is shown in FIGS. 1-4, a different arrangement, including one that employs a plurality of shafts, can be used to communicate rotary power from the powerhead 46 to the tines. For example, a tiller or cultivator 56 configured as a hole digger 40 constructed in accordance with the present invention can have a drive shaft coupled at one end to an output shaft of the powerhead 46 and coupled at its opposite end to the transmission 94. As is also shown in FIGS. 1-4, the shield 64 can be attached to the transmission housing 102 instead of or in addition to being attached to part of the frame or chassis, e.g., part of chassis 62.

With reference to FIG. 3, a footplate 98 can be employed that can be attached to the shield 64 or the transmission housing 102. The footplate 98 can be elongate and generally rectangular having a tread 100 at or adjacent its one end. If desired, the footplate 98 can be attached to part of the chassis 62. Where equipped with a footplate 98, the footplate 98 is located on the same side of the hole digger 40 as the handles 60 with the footplate 98 typically being disposed between the drive shaft 76 and a user of the hole digger 40. The footplate 98 is disposed at a height higher than the tines 44 and typically disposed lower than the powerhead 46 with the footplate 98 extending generally horizontally outwardly toward a user of the hole digger 40 in a manner enabling a foot of a user to stably step on the footplate 98 during rotation of the tines 44.

Where equipped with a footplate 98, the footplate 98 can be located adjacent the hole digger anchor 50 so that a substantial portion of the weight of a user stepping on the footplate 98 is directed to the anchor 50 helping to more securely insert the anchor 50 into the ground 52. In one preferred embodiment, the footplate 98 is located so the direction of the weight of a user stepping on the footplate 98 is substantially the same as the longitudinal or lengthwise axis of the hole digger anchor 50. In such a preferred embodiment, the footplate 98 can overlie at least part of the hole digger anchor 50 enabling a foot of a user to be placed on the footplate 98 during hole digging operation to use their weight to more firmly insert the hole digger anchor 50 into the ground 52 at a location where a hole 54 is desired to be dug. Such a footplate 98 also helps a user to apply downward force on the tines 44 during tine rotation as well as to continue to apply downward force on the anchor 50 as the hole 54 is being dug. Although not shown, where the powerhead 46 is attached directly to the shield 64 or part of the chassis 62 adjacent or adjoining the shield 64, the footplate 98 can be disposed adjacent to or even adjoin part of the powerhead 46.

With continued reference to FIG. 3, the transmission 94 can be generally L-shaped with the rotary tine shaft 96 carried by the transmission housing 102 having one shaft segment 104 extending outwardly from one side of the housing 102 and having another shaft segment 106 extending outwardly from the other side of the housing 102. While the embodiment shown in FIGS. 1-4 has a single set of tines located on each side of the transmission 94, a hole digger 40 constructed in accordance with the present invention, such as a tiller or cultivator 56 modified to function as a hole digger 40, can have two or more sets of tines on each side of the transmission 94 fixed to a corresponding one of the shaft segments 104 of the rotary tine shaft 96. Where equipped with two or more sets of tines on each side, a set of tines located on the same side as another set of tines can rotate counter or in an opposite rotational direction in a counter-rotating tine arrangement if desired. Where equipped with two or more sets of tines on each side, shield 64 can be enlarged to generally overlie the additional sets of tines.

With continued reference to FIGS. 1-4, a hole digger 40 constructed in accordance with the present invention can employ one or more sets 42 of conventional radially extending tiller tines 44 that are the same as used on garden cultivators or tillers of conventional construction because use of the hole digger anchor 50 prevents fore-aft tiller movement allowing the rotating tines 42 to rotate substantially in one place long enough to displace dirt, soil, sand, rocks, and other chunks 90 of ground 52 away from around the anchor 50 forming a hole 54. Suitable tine sets 42 include tine sets 42 of one-piece and unitary construction that can be generally disc-shaped having tines 44 that can be integrally formed therefrom as well as tine sets formed of a plurality of separate tines (not shown) connected together in a manner that can allow removal and replacement of one or more tines.

In the preferred hole digger embodiment shown in FIGS. 1-4, one or more of the tine sets are of a modified hole digging construction having one or more hole digger tines 44′ equipped with one or more deflectors 112 configured to deflect dirt, soil, sand, rocks, and other loose chunks 90 out of and away from the hole 54 being dug. Each deflector 112 is carried by a hole digger tine 44′ and extends axially outwardly from part of the tine 44′ along which the deflector 112 generally radially extends. As a result, the deflector 112 extends axially outwardly of the plane of rotation of the tine set 42′. Such a hole digger tine 44′ is therefore wider than a conventional tiller tine with the tine 44′ possessing a greater axially extending surface area enabling a greater volume of dirt, soil, sand, rocks, and other chunks 90 of ground 52 broken up by rotating tines to be displaced radially outwardly by the hole digger tines 44′ and out of the hole 54 during hole digger operation.

In the preferred hole digger embodiment shown in FIGS. 1-4, the outermost tine set 42′ on each side has one or more hole digger tines 44′ modified to facilitating hole digging. Where a hole digger 40 constructed in accordance with the present invention has more than one set of tines mounted to opposite shaft segments 104 of the tine shaft 96, at least the outer set of tines is a hole digging tine set 42′ with every other tine set disposed between the transmission 94 and the outer tine set 42′ being of conventional construction if desired.

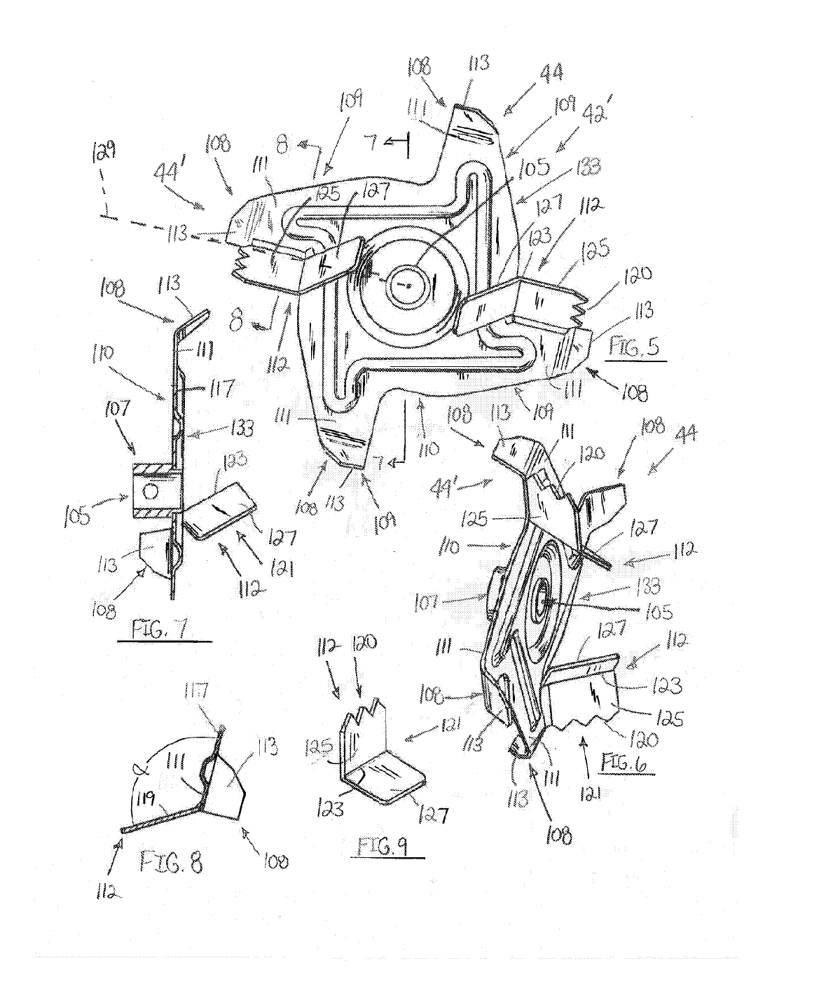

One preferred hole digging tine set 42′ is shown in FIGS. 5-9 having a plurality of tines with at least one tine being a hole digger tine 44′ equipped with a deflector 112. The preferred hole digging tine set 42′ shown in FIGS. 5-9 has a plurality of tines 44 and 44′ with at least one of the tines being a hole digger tine 44′. Each tine 44 and 44′ of the tine set 42′ has at least one tine arm 108 that extends radially outwardly generally away from a centrally located collar 107 used to mount the tine set 42′ to a corresponding shaft segment 104 of the rotary tine shaft 96. Depending on tine set construction, one or more of the tines 44 and/or 44′ can have a tine arm 108 formed at each end of the tine 44 and/or 44′. Each tine arm 108 has a radially extending arm blade 111 that is generally flat or planar and has a bent outer tip 113 that is generally axially and obliquely angled relative to the arm blade 111 to help break up dirt, soil, sand, rocks, and other chunks 90 of ground 52 impacted by the rotating tine 44 or 44′ during hole digger operation. The axial direction of the tine arm tip 113 of each tine arm 108 alternates so the tip 113 of one arm 108 faces generally in an opposite direction relative to the tip 113 of an adjacent arm 108.

For example, with continued reference to FIGS. 5-9, the tine set 44′ has a tine configuration that defines a plurality of pairs, i.e. at least three, tine arms 108 with a plurality of tine arms 108 having a tip 113 obtusely angled relative to the blade 111 in one direction and a plurality of arms 108 having a tip 113 obtusely angled relative to the blade 111 in the opposite direction. When mounted to a segment 104 of a rotary tine shaft 96, the tip 113 of a plurality of tine arms 108 is generally axially angled toward the transmission 94 and the tip 113 of another plurality of tine arms 108 is axially angled away from the transmission 94 and toward an outer periphery of a hole 54 being dug.

With continued reference to the hole digging tine set 42 depicted in FIGS. 5-9, each deflector 112 extends alongside a portion of a corresponding tine arm 108 and can be attached to the arm 108 such as by the use of one or more fasteners, one or more bonds, one or more welds, or the like. For example, in one preferred embodiment, at least part of the deflector 112 is fixed by welding the deflector 112 to at least part of the tine arm 108 of each hole digger tine 44′ attaching the deflector 112 along at least part of one longitudinally extending edge to the arm 108.

Each deflector 112 is attached to an outer surface 117 of a corresponding one of the tine arms 108 that faces outwardly away from the hole digger anchor 50 and transmission 94. When part of a hole digging tine set 42′ attached to the axially outermost portion of a segment 104 of the rotary tine shaft 96, each deflector 112 extends outwardly away from the hole digger anchor 50 and transmission 94 advantageously locating each deflector 112 adjacent the outer periphery or outer peripheral edge of the hole 54 being dug in the ground 52. As a result, dirt, soil, sand, rocks, and other loose chunks 90 deflected by the deflector 112 are more directly deflected radially outwardly and upwardly from and out of the hole 54 being dug.

At least part of each deflector 112 is oriented at an oblique angle relative to the tine arm 108 to which the deflector 112 is attached helping to more efficiently deflect dirt, soil, sand, rocks, and other chunks 90 of ground 52 broken up during tine rotation outwardly and away from the hole 54 in the ground 52 being dug. In a preferred embodiment, at least a portion of the soil deflector 112 extending axially along part of the tine arm 108 is angled at an obtuse angle, α, relative to the arm 108 with the angle, α, ranging between about 100 degrees and about 160 degrees. In a preferred embodiment, the deflector 112 is mounted to the tine arm 108 at an angle, α, relative to the outer generally planar surface 117 of the arm 108 that preferably is about 120 degrees (e.g., 120 degrees±5 degrees).

Each deflector 112 can be three dimensionally contoured in a manner that imparts the shape of a scoop 121 that is disposed alongside a corresponding adjacent tine arm 108 of a hole digger tine 44′ because imparting such a three dimensional contour to one or more of the deflectors 112 can help maximize the amount of dirt, soil, sand, rocks, and other chunks 90 of broken ground 52 deflected by the deflector 112 out of the hole 54 being dug. While one or more of the soil deflectors 112 of each hole digging tine 44′ can be three dimensionally contoured by being curved along a lengthwise or transverse direction, such as by forming a curved soil deflector with a radius of curvature along its lengthwise or transverse direction, one or more of the soil deflectors 112 can be three dimensionally shaped by having a bend 123 dividing the deflector 112 into a pair of deflector panels 125 and 127. If desired, one of the deflector panels 127 can extend farther axially outwardly from the tine 44′ than another one of the deflector panels 125 to help direct dirt, soil, sand, rocks, and other loose chunks 90 of broken ground 52 toward the other one of the deflector panels 125 where it is further deflected outwardly toward the outer periphery of the hole 54 being dug.

In the preferred deflector embodiment shown in FIGS. 5-9, the deflector 112 has a bend 123 extending generally transversely to the longitudinal or lengthwise direction of the deflector 112 dividing the deflector 112 into a radially extending outer deflector panel 125 disposed alongside a portion of an adjacent radially extending tine arm 108 and a generally radially extending inner deflector panel 127 that extends radially inwardly generally toward the central collar 107. A radially outermost edge 120 of the deflector 112 can be serrated as shown in FIGS. 1-9 to help facilitate breaking up of the ground 52 engaged by the deflector 112 during tine rotation during hole digging.

The radially outermost deflector panel 125 adjoins a portion of an adjacent tine arm 108 that preferably is part of the radially outwardly extending tine blade 111 and is inclined at an obtuse angle, α, relative to the tine arm blade 111 that can range between 100 degrees and 160 degrees and which preferably is about 120 degrees (120 degrees±5 degrees). Angling the outermost deflector panel 125 relative to the generally flat or planar tine arm blade 111 defines a ramp that is angled away from the tine arm 108 and away from the transmission 94 thereby deflecting dirt, soil, sand, rocks, and other chunks 90 of broken ground 52 generally axially outwardly away from the tine arm 108 and the transmission 94 and away from the center of the hole 54 being dug.

Where the deflector 112 includes a radially innermost deflector panel 127, the deflector panel 127 extends alongside part of the tine 44′ that is disposed radially inwardly of the part of the tine arm 108 alongside which the radially outermost deflector panel 125 is disposed. The radially innermost deflector panel 127 is angled relative to the radially outermost deflector panel 125 in a manner such that the innermost deflector panel 127 extends toward a radial 129 extending from a center of the tine shaft collar 107 to the tine arm 108 carrying the deflector 112 helping deflect dirt, soil, sand, rocks, and other chunks 90 of broken ground 52 within the hole 54 radially toward the outermost deflector panel 125. Deflecting dirt, soil, sand, rocks, and other chunks 90 radially outwardly in this manner accelerates the dirt, soil, sand, rocks, and other chunks 90 before the outermost deflector panel 125 further accelerates the dirt, soil, sand, rocks, and other chunks 90 radially outwardly and upwardly out of the hole 54. The radially innermost deflector panel 127 is also disposed at an obtuse angle relative to the tine arm 108 to help impart at least some momentum to dirt, soil, sand, rocks, and other chunks 90 of broken ground 52 deflected by the panel 127 in a direction away from the tine arm 108 and transmission 94 thereby directing the deflected dirt, soil, sand, rocks, and other chunks 90 of broken ground 52 toward the outer edge of the hole 54 being dug. Innermost deflector panel 127 can be disposed at an obtuse angle that is substantially the same as the angle, α, of the outermost panel 125 if desired.

The hole digging tine set 42′ shown in FIGS. 5-9 has a plurality of tines formed of tine arms 108 that extend generally radially outwardly relative to the mounting collar 107 of the tine set. Each one of the tine arms 108 extends radially outwardly from a centrally disposed tine body 110 that can include a generally planar or flat central spider 133 through which a hole 105 extends that receives part of a corresponding shaft segment 104 of the rotary tine shaft 96. In the preferred hole digging tine set embodiment depicted in FIGS. 5-9, the tine body 110 can have a generally circular spider 133 but preferably has a generally trapezoidal shape that can be generally square with a tine arm 108 extending generally radially outwardly from each one of the four corners 109 of the spider 133. Although generally planar, the spider 133 of the tine body 110 can have a three dimensionally contoured rib 97 integrally formed therein that stiffens and structurally rigidifies the tine set 42′.

In the preferred hole digging tine set 42′ shown in FIGS. 5-9, the tines 44 and 44′ and body 110, including central spider 133, can be and preferably are formed of a single sheet or plate of material, e.g., metal, which is three dimensionally formed and stamped to produce the spider 133 and each tine arm 108. Each deflector 112 is attached to part of a plurality of spaced apart tine arms 108 of at least one hole digger tine 44′ such that deflectors 112 are attached to oppositely outwardly extending tine arms 108. A plurality of deflectors 112 can be configured as a kit that an end user attaches to one or more tine arms 108 of a conventional tiller tine or tiller tine set in converting a conventional tiller or cultivator to a hole digger 40 constructed in accordance with the present invention.

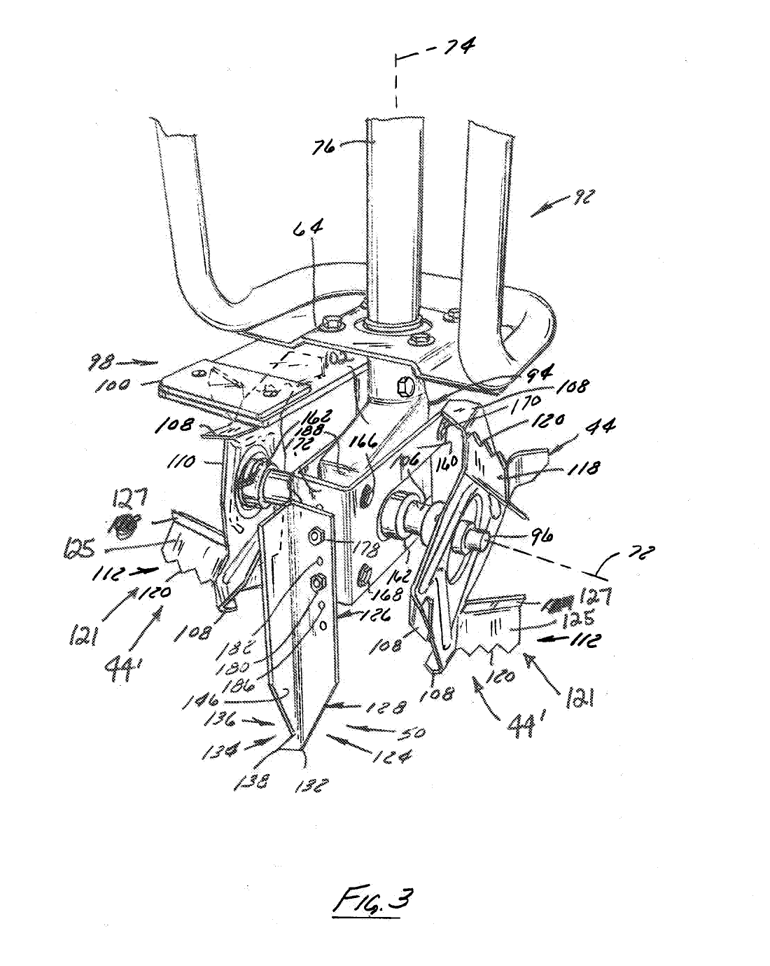

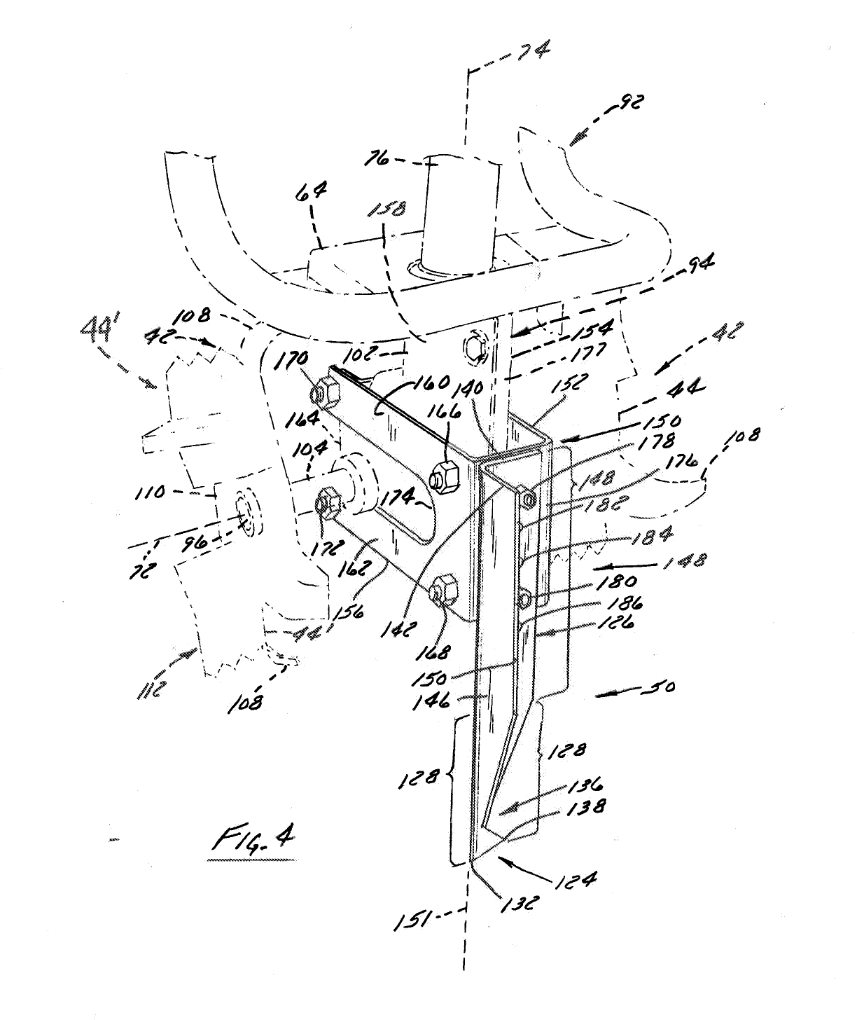

With specific reference to FIGS. 3 and 4, the hole digger anchor 50 is an elongate anchor stake 124 having a shank 126 and a necked down free end 128 that converges to a width or diameter smaller than a downwardly extending part 130 of the shank 126 disposed at or adjacent where the stake 124 mounts to the hole digger 40 or a tiller 56 being converted to a hole digger 40. In the preferred hole digger anchor embodiment shown in FIGS. 1-4, the anchor stake 124 converges at or adjacent its free end 128 forming a point 132 at the end of the free end 128 that facilitates insertion of the anchor stake 124 into the ground 52 at a location where a user of the hole digger 40, e.g., tiller 56 equipped with hole digger anchor 50, desires to dig a hole 54. The stake 124 has a length great enough to extend to a depth deeper than a radially outermost portion of the tines 44 of each tine set 42 attached to the rotary tine shaft 96 when the stake 124 is inserted into the ground 52 thereby preventing fore-aft movement of the hole digger 40 during tine rotation.

In one embodiment, the hole digger anchor stake 124 has a length such that it extends to a depth that is at least 25% greater than a largest tine radius of the tines 44 defined from the tine rotational axis 72 to a radially outermost portion of the tines 44, e.g., free end of tine arm 108. In one preferred embodiment, the stake 124 has a length sufficient to extend to a depth that is at least 50% greater than the largest tine radius of the tines 44. In a preferred embodiment, the stake 124 has a length such that it extends to a depth that is at least 25% greater than the largest tine radius of the tines 44 and no greater than 200% greater than the largest tine radius of the tines 44. In another preferred embodiment, the stake 124 has a length such that it extends to a depth that is at least 25% greater than the largest tine radius of the tines 44 and no greater than 100% greater than the largest tine radius of the tines 44. In a still further preferred embodiment, the stake 124 has a length such that it extends to a depth that is at least 50% greater than the largest tine radius of the tines 44 and no greater than 100% greater than the largest tine radius of the tines 44. Such a stake length insures insertion of the hole digger anchor stake 124 into the ground 52 to a depth correspondingly deeper than that of the tines 44 ensuring that the hole digger 40 will not “walk” or otherwise move in a fore or aft direction when the tines 44 engage the ground 52 while the tines 44 are rotating. In other words, such a stake length advantageously ensures that the hole digger 40 will remain in one place once the stake 124 is inserted while the tines 44 rotate enabling the rotating tines 44 to dig a hole 54 by engaging and flinging ground matter 90 out of the hole 54 and onto the ground 52 next to the hole 54 without the hole digger 40 moving fore-aft along the ground 52.

As is also shown in FIGS. 3 and 4, the necked down free end 128 can be configured with a hook 134 formed therein that helps prevent withdrawal of the hole digger anchor stake 124 once the stake 124 has been inserted into the ground 52 in preparation for hole digging. Such a hook 134 also helps keep the stake 124 in the ground 52 preventing its withdrawal during hole digging. With continued reference to FIGS. 3 and 4, the hook 134 is a notch defining a gape 136 with a barb 138 that extends in a direction generally transverse or perpendicular to the tine axis of rotation 72 to help stop any fore or aft motion of the hole digger 40 while the stake 124 is fully inserted into the ground 52. Whether mounted to the front of the transmission housing 102, whether mounted to the rear of the housing 102, or whether extending downwardly from the housing 102 at any location therebetween, such a hole digger anchor stake configuration advantageously prevents withdrawal of the stake 124 once it has been fully inserted into the ground 52 when the tines 44 are rotating during hole digging.

With reference to FIGS. 1, 2 and 4, the stake 124 is mounted to the front of the transmission housing 102 and oriented so the gape 136 and barb 138 face forwardly helping which only opposes stake withdrawal but also helps keep the hole digger 40 anchored in place during hole digging. With reference to FIG. 3, the stake 124 can also be mounted to a rear of the housing 102 with the gape 136 and barb 138 facing rearwardly. The stake 124 can also be rear mounted with the gape 136 and barb 138 facing forwardly.

The stake 124 shown in FIGS. 1-4 can be generally Vee-shaped having a plurality of elongate legs 140 and 142 disposed at an angle relative to one another. With specific reference to FIG. 4, the elongate legs 140 and 142 of the stake 124 depicted in FIGS. 1-4 are respectively defined by one flange 144 oriented with its width generally parallel to the tine rotational axis 72 and another flange 146 oriented with its width disposed at an angle less than 180° relative to flange 144. With continued reference to FIG. 4, while flange 144 can be obliquely angled relative to flange 146, flange 144 is generally parallel to the tine rotational axis 72 and flange 146 is generally transverse and can be generally perpendicular to the tine rotational axis 72. Each flange 144 and 146 is generally rectangular except where necked down. For example, in the stake embodiment shown in FIGS. 1-4, the stake 124 is formed of a section of generally right-angled angle iron having the necked down portion 128 formed in both flanges 144 and 146 and the hook 134 formed only in one of the flanges 144. If desired, hook 134 can be formed in both flanges 144.

The hole digger anchor stake 124 shown in FIGS. 1-4 is part of a hole digger anchor assembly 148 that includes a mounting bracket 150 used to attach the assembly 148 to the transmission housing 102 in a secure manner holding the stake 124 in the desired position where a longitudinally extending axis 151 of the stake 124 extends downwardly generally transverse to the tine rotational axis 72 and generally parallel to the powerhead shaft axis 74. While the mounting bracket 150 can be removably attached to the transmission housing 102, the bracket 150 can be permanently fixed or affixed to the housing 102. If desired, the transmission housing 102 can be integrally formed, such as by casting, molding or the like in a manner that provides a mounting arrangement enabling mounting of the stake 124 directly to the housing 102 obviating the need for a separate mounting bracket 150.

The bracket 150 shown in FIG. 4 is generally U-shaped having one mounting plate 152 disposed along one side 154 of the transmission housing 102 and another mounting plate 156 disposed along the other side 158 of the housing 102. Each mounting plate 152 and 156 is also generally U-shaped having a pair of elongate mounting plate arms 160 and 162 spaced apart to straddle a rotary tine shaft support 164, e.g., bearing or bearing housing, extending outwardly from the transmission housing 102. As is also shown in FIG. 4, the space between the mounting plate arms 160 and 162 defines an elongate slot 174 providing adjustability enabling use of the mounting bracket 150 with transmission casings of different tillers.

A plurality of fasteners are used to attach the bracket 150 to the transmission housing 102 with a first pair of upper and lower fasteners 166 and 168 connecting one mounting plate 152 to the other mounting plate 156 and a second pair of upper and lower fasteners 170 and 172 respectively connecting each mounting plate arm 160 and 162 of one plate 152 to the arm 160 and 162 of the other plate 156. Each fastener 166, 168, 170 and 172 can be a threaded bolt attached by a nut threaded onto the bolt in a manner that clamps the mounting plates 152 and 156 around the transmission housing 102 defining a mounting clamp. If desired, one or more of the fasteners 166, 168, 170 and 172 can directly engage part of the transmission housing 102 such as by extending through part of the housing 102 and/or being threaded into part of the housing 102.

A stake mount 176, such as in the form of a generally planar stake mounting plate, overlies a front 177 of the transmission casing extends between the mounting plates or clamp plates 152 and 156 of the mounting bracket 150 and has the stake 124 attached to it. The stake 124 can be attached to the stake mount 176 in a manner that permits removal of the stake 124 from the tiller 56 such as where it is desired to use the tiller 56 to till soil without digging any hole. For example, as is shown in FIG. 4, a plurality of fasteners 178 and 180 can be used to attach the stake 124 to the mount 176 having a nut on each fastener that is removable to enable removal of the stake 124 from the mount 176. As is also shown in FIG. 4, the stake 124 includes a plurality of additional spaced apart mounting bores 182, 184 and 186 through which one of the fasteners 178 and 180 can extend enabling depth adjustment of the stake 124, such as to adjust stake depth for digging holes in ground of different compositions, types, and hardness.

As is more clearly shown in FIG. 3, the stake mount 176 can be configured with a plurality of pairs of fastener bores to further facilitate stake depth adjustability. Where it is desired to mount the stake 124 between a rear 188 of the transmission housing 102 and a user of the tiller 56, the bracket 150 can be mounted to the housing 102 with its stake mount 176 overlying and even bearing against the rear 188 of the housing 102. If desired, the transmission housing 102 can be integrally formed, such as by casting, molding or the like in a manner that integrally incorporates such a stake mount, e.g., stake mount 176, configured in a manner that enables removable and adjustable mounting of the stake 124, such as by using a plurality of fasteners or the like. Such an integrally formed stake mount would also obviate the need for a separate stake mounting bracket 150.

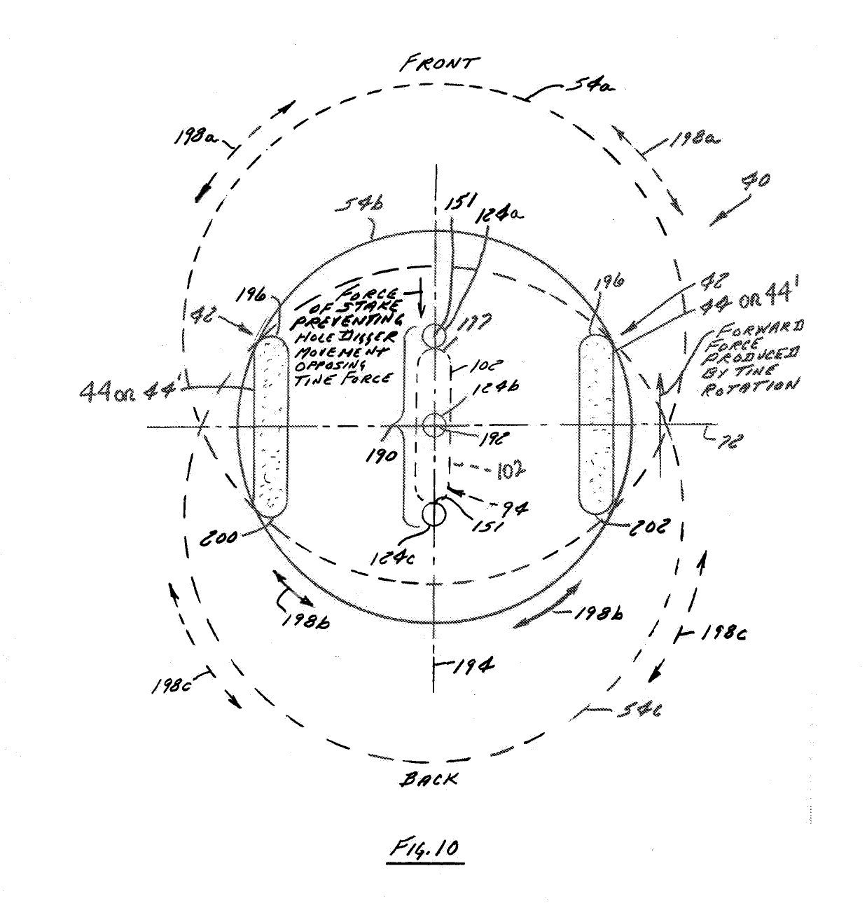

FIG. 10 is a schematic diagram illustrating a first preferred range 190 of positions of the hole digger anchor stake 124a, 124b and 124c relative to a center tine axis 192 of the hole digger 40, e.g., tiller 56, that extends perpendicularly to and through the axis of rotation 72 of the tines 44 enabling the anchor stake 124a, 124b or 124c to also function as a pivot generally corresponding to the longitudinal stake axis 151. While three positions of the stake 124a, 124b or 124c are shown in FIG. 10, the hole digger anchor stake can be positioned anywhere therebetween in the preferred range 190 depicted in FIG. 10. For example, in the preferred configuration depicted in FIG. 10, the hole digger anchor stake can be positioned within this range 190 along a generally horizontally extending bisector 194 that is also generally perpendicular to rotary tine axis 72 and vertical center tine axis 192.

In the preferred configuration and stake position range depicted in FIG. 10, the intersection of axes 72, 192, and 194, e.g., x-axis 72, y-axis 194, and z-axis 192, defines an origin through which a hole digger anchor stake can be positioned, such as the position of hole digger anchor stake 124b. Bisector 194 bisects the rotary tine shaft 96 halfway between the outermost tines 44 and can bisect the housing 102 of the transmission 94 in a longitudinal direction relative to the housing 102 in the manner depicted in FIG. 10. The center tine axis 192 extends vertically generally perpendicular to the rotary tine axis 72 generally parallel to or acutely angled relative to powerhead shaft axis 74. The center tine axis 192 is centrally located equidistantly between the outermost sets 42 of tines 44. By providing an elongate hole digger anchor stake, e.g., stake 124a, 124b and/or 124c, which is positioned between the tines 44 or sets 42 of tines 44 on each side of the transmission 94, the stake 124a, 124b or 124c functions as a pivot about which the rotating tines 44 are rotated during hole digging.

As further illustrated by FIG. 10, the hole digger anchor stake 124 can be positioned anywhere within range 190 such that the stake 124 is located interjacent outermost tines 44 or outermost tine sets 42. In a forward-most stake position, hole digger anchor stake 124a is located adjacent a front 177, e.g., front or forward facing surface, of the transmission housing 102 having its generally vertically extending stake axis 151 disposed in the middle between a forward radially outermost extending portion 196 of both outermost tines 44. As is also shown in FIG. 10, stake 124a is located halfway between outermost tines 44 and has a portion through which rotary tine axis bisector 194 extends. While the stake 124a is depicted as being oriented with its longitudinal stake axis 151 being generally vertical and generally perpendicular to the center tine axis 192, stake 124a can be oriented with its stake axis 151 obliquely, e.g., acutely, acutely angled relative to center tine axis 192. For example, it is contemplated that the stake 124a (or any stake, e.g., stake 124b and/or 124c positioned along stake range 190) can be acutely angled relative to tine center axis 192 toward the axis 192 such that the free end 128 of the stake 124a is located closer to the tine center axis 192 than part of the shank of the stake 124a disposed adjacent or along a transmission housing 102. Longitudinal stake axis 151 is illustrated in FIGS. 2 and 4 as extending along the longest edge or portion of the hole digger anchor stake 124, but can also extend longitudinally through a center of the stake 124.

During hole digger operation, the stake 124a of the hole digger anchor 50 is inserted into the ground 52 and the tines 44 and/or 44′ rotated, such as via manual actuation by the user interacting with one or more of the controls on board the hole digger 40. As the tines 44 and/or 44′ rotate, they engage the ground 52 breaking up the ground 52 also creating a thrust force generally perpendicular to the tine axis of rotation 72 that tends to urge the hole digger 40 forwardly. As a result of the construction and location of the stake 124a relative to the transmission 94 and the tines 44, stake 124a insertion into the ground 52 prevents any substantial forward hole digger movement from occurring substantially anchoring the hole digger 40 in place. This in turn causes the tines 44 and/or 44′ to rotate in place propelling ground 52 broken up by the tines 44 and/or 44′ upwardly and outwardly out of a hole 54 created by the tines rotating in place.

During hole digging, a user grasping the handles 60 pivots or swivels the hole digger 40 about the stake 124a of the hole digger anchor 50 with the stake 124a serving as a pivot or center of rotation about which the tines 44 rotate. The hole digger 40 is pivoted by the user about the stake 124a through an angular extent 198a of at least 35° to ensure that a generally circular hole 54 is produced. In one preferred method of digging a hole, the hole digger 40 is pivoted about the stake 124a in one direction, e.g., clockwise, at least about 45°, pivoted back to the original home position shown in FIG. 5, and then pivoted about the stake 124a in an opposite direction, e.g., counterclockwise, at least about 45°. Such a back-and-forth pivoting motion about the stake 124a can be done a plurality of times until a hole 54a of a desired depth is produced. In one preferred method of digging a hole, the hole digger 40 is pivoted back and forth about the stake 124a at least 35° clockwise and at least 35° counterclockwise until a hole 54a having a desired depth of at least four inches is produced.

In another method of digging a hole, e.g., hole 54a, the user grasping the handles 60 pivots the hole digger 40 about the stake 124a, while the tines 44 and/or 44′ are rotating with the stake 124a anchored in the ground 52, at least 60° in one direction, e.g., clockwise or counterclockwise, from the home position shown in FIG. 5 and then pivots the hole digger 40 in an opposite direction, e.g., counterclockwise or clockwise, back to the home position. This can also be done a plurality of times until a hole 54a of a desired depth is produced.

Where the stake 124b is generally centrally positioned between the tines 44 and/or 44′ such that the stake 124b is disposed adjacent the origin where axes 72, 192 and 194 intersect or has a portion extending through or adjacent the origin as also depicted in FIG. 10, pivoting about the stake 124b while the tines 44 are rotating in accordance with one or more of the hole digging methods described in one or more of the preceding paragraphs produces a hole 54b that can be circular as depicted. Of course, such a hole produced using a hole digger 40 constructed in accordance with the present invention can deviate somewhat from being circular, such as by being generally circular, oval, oblong or the like.

As is also depicted in FIG. 10, the stake 124c can also be positioned with its generally vertically extending stake axis 151 disposed in the middle between a rearward radially outermost extending portion 200 of both outermost tines 44′. For example, stake 124c is shown in FIG. 10 disposed adjacent or alongside a rear 188, e.g., back or rearward facing surface, of the transmission housing 102 having its generally vertically extending stake axis 151 disposed in the middle between the rearward radially outermost extending portion 200 of tines 44′. Operation of the hole digger 40 to dig a hole 54c is substantially the same as the method or methods of hole digging described in one or more of the preceding paragraphs.

FIG. 11 illustrates second preferred hole digger anchor stake position range where the stake 124d or 124e can lie anywhere within a circle 202 produced by pivoting the tines 44 and/or 44′ about generally vertical central axis 192 and preferably within a stake position range 204 where the stake is located anywhere within the circle 202 and generally along bisector 194. When pivoted from the home position depicted in FIG. 11 about stake 124d along one or a plurality of angular extents, e.g., angular extent 198d′ and/or angular extent 198d″, back-and-forth in accordance with a method of hole digging the same or substantially the same as discussed above with regard to FIG. 10, a hole 54d that typically is larger than holes 54a, 54b or 54c shown in FIG. 10 is produced. Likewise, when pivoted from the home position depicted in FIG. 11 about stake 124e along one or a plurality of angular extents, e.g., angular extent 198e′ and/or angular extent 198e″, back-and-forth in accordance with a method of hole digging the same or substantially the same as discussed above with regard to FIG. 10, a hole 54e is produced.

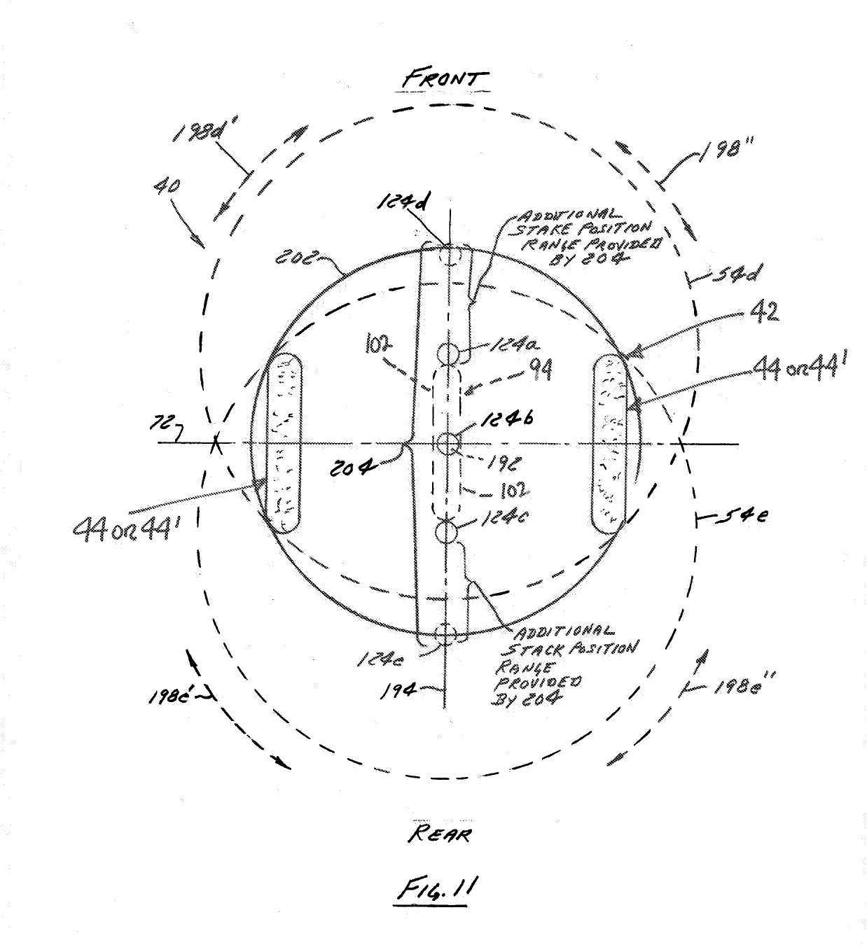

Additional hole digger anchor configurations are contemplated as being within the scope of the present invention. For example, FIG. 12 illustrates a hole digger anchor 50b employing a hole digger mounting arrangement 206 that mounts to or around a rotary tine shaft support housing 102 and which has a plurality of hole digger anchor stakes 124′ and 124″ on opposite sides of the transmission 94. The hole digger mounting arrangement 206 can include a mounting bracket 208 configured to securely hold a forwardly located stake 124′ located in front of the transmission 94 and to securely hold a rearwardly located stake 124″ located behind the transmission 94. Such a mounting arrangement 206 can be configured to be fixed to the transmission 94, clamped around the transmission 94, or be integrally formed as part of the transmission 94. As is also shown in FIG. 12, one of the hole digger anchor stakes, e.g., stake 124′ can be generally vertically oriented with its stake axis 151′ disposed generally or substantially vertical and generally parallel to central vertical tine axis 192 and another one of the stakes, e.g., stake 124″ can extend generally vertically upwardly with its stake axis 151″ disposed at an acute angle relative to the other stake 124′ and central vertical tine axis 192 (and can intersect one or both axes 151′ and 192). If desired, the arrangement can be reversed with stake 124′ being rearwardly disposed and stake 124″ being forwardly disposed.

Each such mounting arrangement can be configured to be attached to a tiller during or shortly after its manufacture. Each such mounting arrangement can also be configured as a kit that is included with the retail packaging or shipping box in which a tiller is shipped and/or sold. Each such mounting arrangement can also be configured as a kit that is separately packaged and sold in a retail store or the like for purchase by an existing owner of a tiller enabling the owner to add hole digging capabilities to their existing tiller. Such a kit preferably includes the mounting arrangement, e.g., one or more mounting plates or the like, along with suitable mounting hardware, e.g. bolts, screws, nuts and the like, and one or more hole digger anchor stakes. The same holds true of all of the embodiments shown in the drawing figures and described above and below.

FIG. 13 illustrates another preferred embodiment of a hole digger anchor 50c having a hole digger anchor stake 124 extending outwardly from a hole digger anchor mounting arrangement 210 that can be a collar 212 integrally formed of part of the transmission 94 e.g., transmission housing 102, or attached to the housing 102 using fasteners or the like. As is shown in FIG. 13, the stake 124 is generally vertically oriented with its longitudinal axis 151 generally parallel to the central vertical tine shaft axis 192 with the stake 124 extending downwardly a portion of the transmission housing 102. As is also shown in FIG. 13, the stake 124 is offset from the central vertical tine axis 192 having its longitudinal axis 151 disposed forwardly of axis 192.

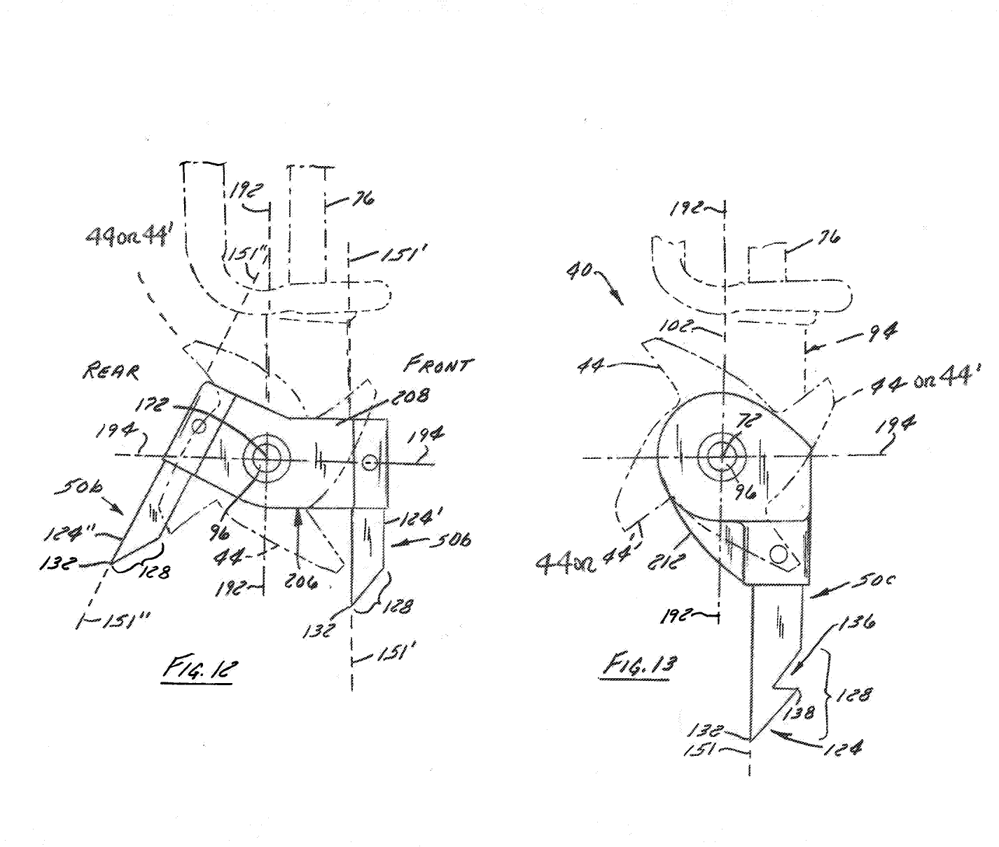

FIG. 14 illustrates another preferred hole digger stake mounting arrangement 214 that mounts the hole digger anchor stake 124 so a portion of it, such as its shank, is disposed alongside the front 177 of the transmission housing 102. Stake 124 is similar to the hole digger anchor stake 124 shown in FIGS. 1-4, but has a barb 138′ with a blunt front edge 216 that faces forwardly that is disposed above the necked down portion 128′ of the free end of the stake 124.

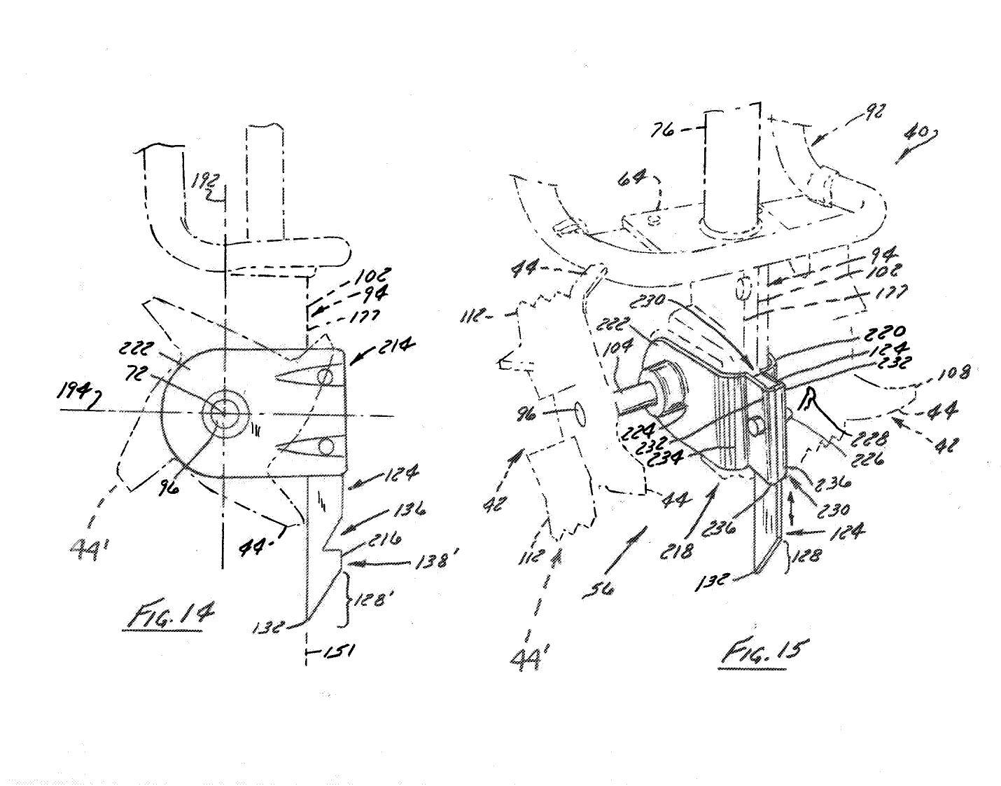

FIGS. 15 and 16 illustrate a further preferred hole digger stake mounting arrangement 218 formed of a plurality of three dimensionally contoured mounting plates 220 and 222 that are each three dimensionally formed with a rotary tine shaft bearing collar 224 that locates and seats each mounting plate 220 and 222 in registry with a corresponding rotary tine shaft bearing or bearing holder of the transmission housing 102. Each collar 124 is annular and recessed having a three dimensionally complementary shape or contour with that of a generally cylindrical and axially outwardly extending rotary tine shaft bearing or bearing holder of the transmission housing 102. During assembly, the collar 124 of each mounting plate 220 and 222 generally coaxially registers with the rotary tine shaft bearing or bearing holder of the transmission housing 102 thereby helping to attach and locate a respective one of the mounting plates 220 and 222 to the transmission 94. The mounting plates 220 and 222 can be held together by a fastener, including a fastener, such as a removable pin 226, used to removably and/or adjustably attach the anchor stake 124 thereto. Although the pin 226 is removable, it is held in place securely by a Cotter pin 228 or the like that extends through a bore in the pin 226 once the pin 226 is inserted through the mounting plates 220 and 222 and stake 124 in the manner depicted in FIG. 15. Although not shown in the FIG. 15, the hole digger anchor stake 124 can have a plurality of spaced apart pin receiving bores through which removable pin 226 can be inserted thereby providing stake depth adjustability.

The mounting plates 220 and 222 are three dimensionally formed to mate and defining a stake receiving channel 230 having a cross-sectional configuration complementary to the hole digger anchor stake 124 that is received in the channel 230. Each plate 220 and 222 has a leg 232 extending outwardly away from the transmission housing 102 and a transmission abutment 234 with each leg 232 generally overlying one another by being spaced apart by a lip 236 defining the stake receiving channel 230 therebetween. In the preferred mounting arrangement shown in FIG. 15, one side or edge of the channel 230 can be formed by a front or back, e.g. front 177, of the housing 102. If desired, the mounting arrangement 218 can be integrally formed of a single sheet of material, such as a single sheet of metal, e.g. steel, aluminum, or the like, which is formed in the manner shown in FIG. 15 and mounted to the transmission housing 102 prior to assembly of the rotary tine shaft 96 (or a respective shaft segment 104 and 106). Where the mounting arrangement 218 is of one-piece and unitary construction, it can clamp around the cylindrically outwardly extending bearing holders or bearings that protrude from opposite sides of the transmission housing 102 enabling the mounting arrangement 218 to be held in place until the anchor stake is inserted into the channel 230 formed between the mounting arrangement 218 and transmission housing 102 and secured in place within the channel 230.

Such a mounting arrangement 218 can also be formed of a pair of sheets, e.g., stamped, three dimensionally formed in a press, forged, or the like, which are attached along an opposed edge of lip 236, such as by welding or the like. Such a mounting arrangement 218 advantageously enables a tiller 56, such as preferably a mini-tiller, to be manufactured with the ability to attach, adjust, and then completely remove anchor stake 124. This advantageously enables the tiller 56 to be quickly and conveniently converted between a hole digger 40, when it is desired to dig a hole, and a conventional walk behind tiller or garden cultivator when it is desired simply to break up or till soil. In a preferred embodiment, such a mounting arrangement 218 can be configured to be retrofitted onto an existing tiller, such as by being purchased as a kit that includes one or more hole digging anchor stakes, e.g., anchor stake(s) 124.

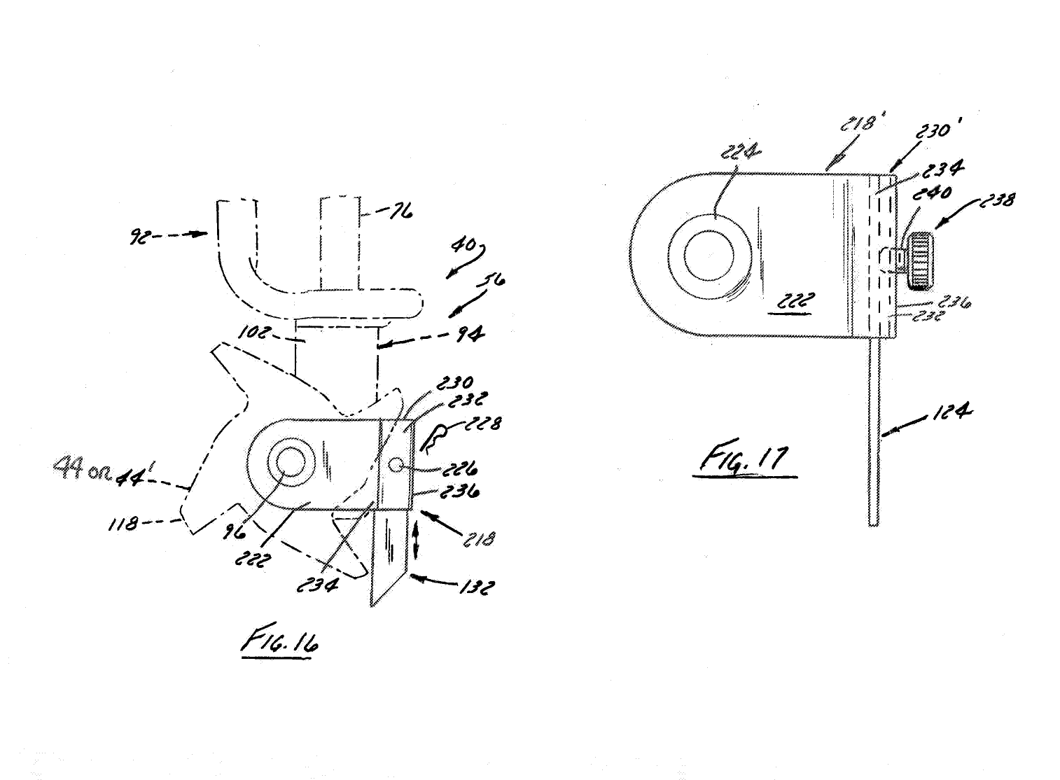

FIG. 17 depicts a mounting arrangement 218′ similar to the mounting arrangement 218 illustrated in FIGS. 15 and 16 but which uses a thumb screw or knob 238 in place of removable fastener 226. The thumb screw or knob 238 can be and preferably has a threaded shank or stem 240 (not shown) that is threaded into a portion of the mounting arrangement 218′ and/or the transmission housing 102. Such a thumb screw or knob 238 can extend through a bore in the hole digger anchor stake 124 or can frictionally engage a surface of the stake 124 to hold the stake 124 in a desired position, also providing depth adjustability. While a single thumb screw or knob 238 is shown in FIG. 17, mounting arrangement 218′ can be configured to accommodate a plurality of thumbscrews or knobs 238, if desired.

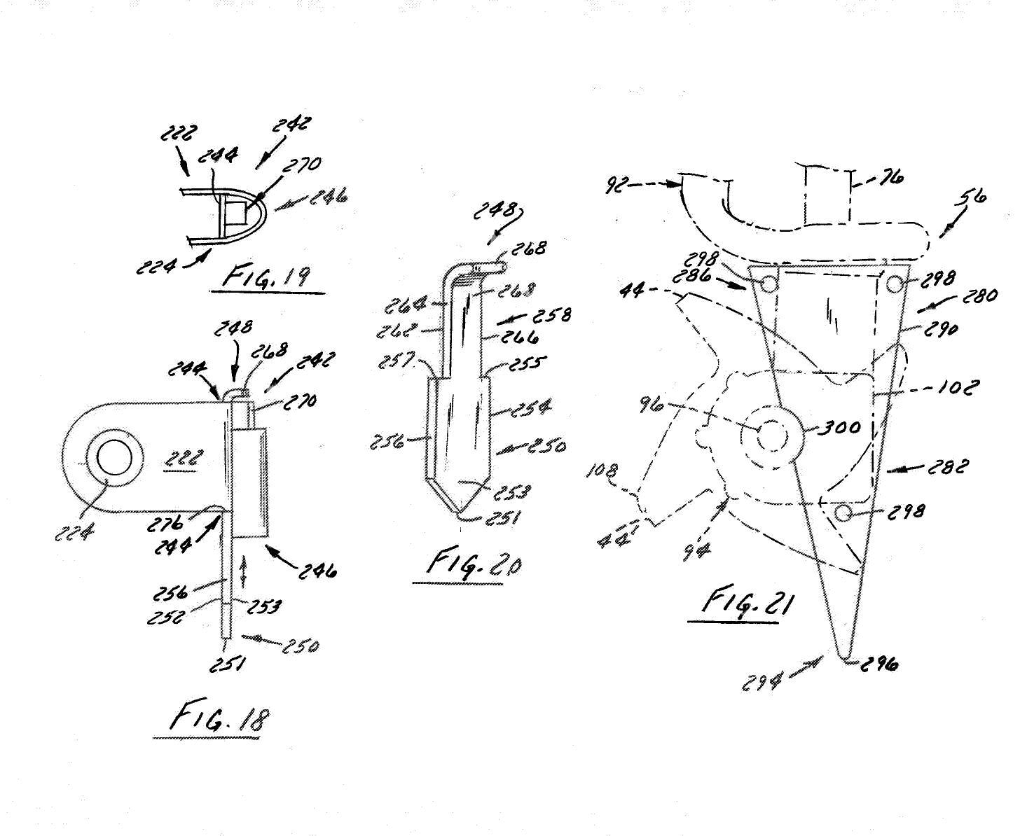

FIGS. 18 and 19 illustrate another preferred mounting arrangement 242 having a mounting plate arrangement or assembly that is similar in construction to that depicted in one or more of FIGS. 15-17 but which includes a hole digger anchor stake, e.g. anchor stake 124, constructed in accordance with the present invention received in a stake receiving channel 244 that engages with a stake position locking arrangement 246 having a manipulable control 270, such as a depressible button, that enables the depth of an anchor stake 124 received in the channel 244 to be adjusted and locked in place without the use of any screw or bolt. Stake position locking arrangement 246 is fixed to one or both plates 220 and 222 of the mounting arrangement 242 and can be disposed anywhere along the transmission housing 102, including adjacent or along a front or rear of the housing 102.

FIG. 20 illustrates a preferred embodiment of an anchor stake 248 that is similar to stake 124 of which is configured for receipt in channel 244 in a manner that cooperates with the stake position locking arrangement 246. Stake 248 includes an anchor spade segment 250 that has a pair of opposed ground engaging sides or sidewalls 252 and 253, e.g., front and back, side edges 254 and 256, and shoulders 255 and 257, from which a narrower segment 258 upwardly extends that is configured for receipt in the channel 244 and for cooperation with the stake position locking arrangement 246. Anchor spade segment 250 can be configured with a pointed end 251 as depicted in FIG. 15.

The narrower channel disposed segment 258 of the stake 248 also has a pair of sides or sidewalls 260 and 262 and side edges 264 and 266 along with a manipulable handle 268 that can be manually engaged to move the stake 248 to an out of the way position. For example, when the stake 248 shown in FIG. 18 is moved to an out of way position, the anchor spade segment 250 that normally would be inserted into the ground 50 is displaced or retracted upwardly so that it does not engage the ground 50 during tiller operation. Such a mounting arrangement 242 advantageously enables the stake 248 to remain attached to the tiller, e.g., mini tiller 56, at all times and to be extended only when converting the tiller to a hole digger and to be retracted when converting it back to a tiller. In a preferred embodiment, the stake position locking arrangement 246 is also configured to provide stake depth adjustment, such as by locking the stake 248 in place, such as via frictional engagement once the control 270 is pressed or released, at one of a plurality of depths and which can provide analog or substantially infinite depth adjustment over a limited depth adjustment range. In one preferred embodiment, pressing the control 270 of the locking arrangement 246 disengages the stake 248 from the locking arrangement 246 allowing the stake 248 to be extended or retracted by grasping its handle 268 and pulling or pushing the stake 248 accordingly. Releasing the control 270 engages the stake 248, such as by frictional engagement or the like, locking the stake 248 in place.

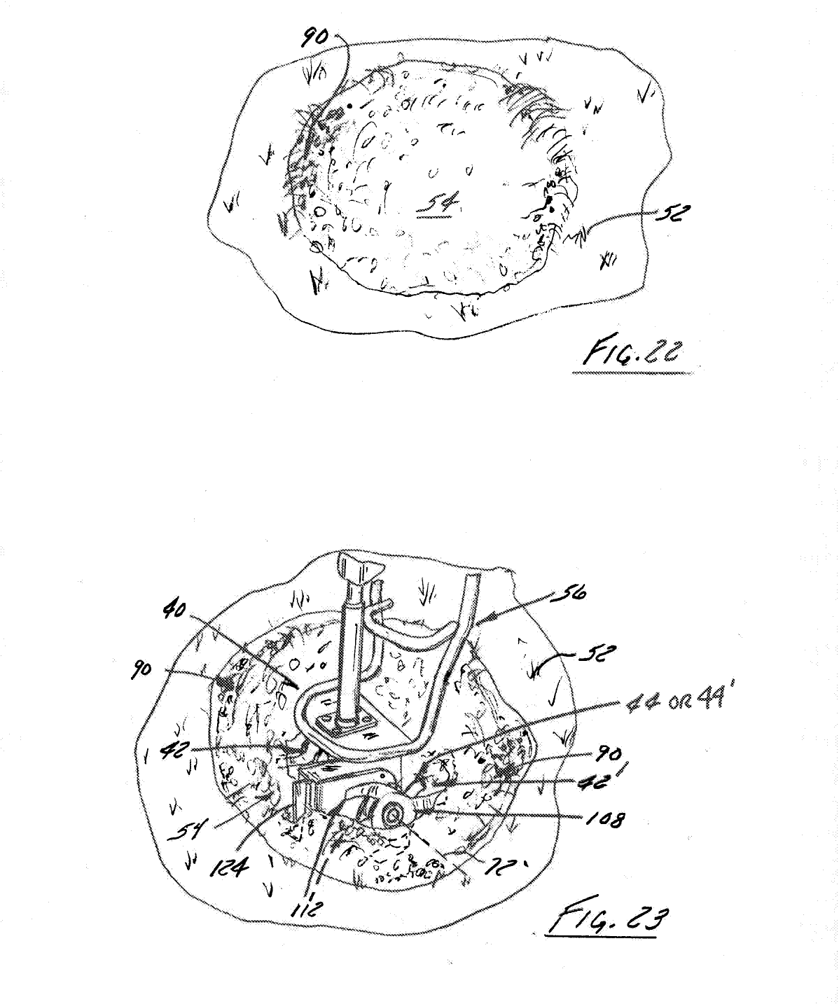

FIG. 21 illustrates another preferred anchor stake embodiment that is a sleeve 280 attached to the transmission housing 102 of a tiller 56 that preferably is a mini-tiller that lacks any wheels, lacks any depth stake, and lacks any depth indicator. The sleeve 280 includes an integral mounting arrangement 282 that can be formed of a plurality of plates or halves 284, only one of which is shown in FIG. 21. The anchor stake sleeve 280 shown in FIG. 21 has a relatively wide base portion 286 encompassing a top portion of the transmission housing 102 and can include mounting or clamping fasteners 288 used to attach or clamp the anchor stake sleeve 280 in place. The anchor stake sleeve 280 has a pair of converging front and rear sides 290 and 292 that converge at its ground-engaging free end 294 forming a point 296 that can have a rounded or tapered end as depicted in FIG. 21. One or more fasteners 298 disposed adjacent to a bottom, front or rear of the transmission housing 102 can be used in mounting the anchor stake sleeve 280 to the housing 102. As is also shown in FIG. 21, one side of the anchor stake sleeve 280 can have an arcuate locator notch 300 that seats against in registry with a portion of an outwardly extending generally circular protrusion of the rotary tine shaft bearing holder or bearing.

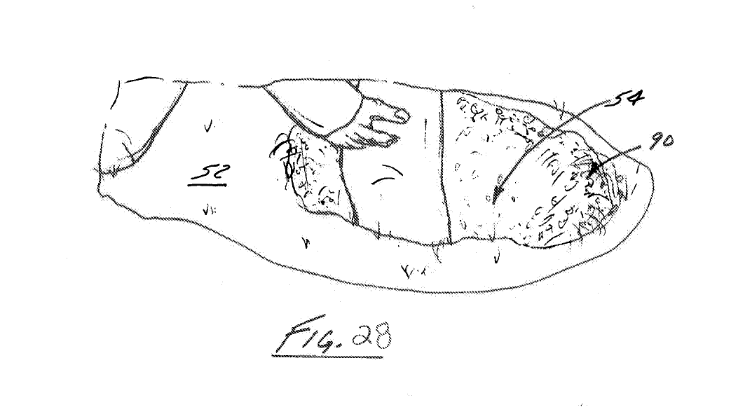

With reference to FIGS. 22-28, a tiller 56 configured with a hole digger anchor 50 forms a hole digger 40 constructed in accordance with the present invention. A tiller 56 that is particularly well-suited for use with a hole digger anchor 50 is a mini tiller equipped with a hole digger anchor 50 positioned relative to the tines 44 and/or 44′ and axis 192 and/or axes 72 and 194 in accordance with that depicted in FIG. 10 with the mini tiller lacking any drag stake or depth indicator and preferably also lacking any wheels. Where wheels are used, they preferably are taken off or located in and out of the way position that does not interfere with hole digging operation of a digger anchor equipped mini tiller. The same is true for any drag stake or depth indicator as either or both can be and preferably are removed.

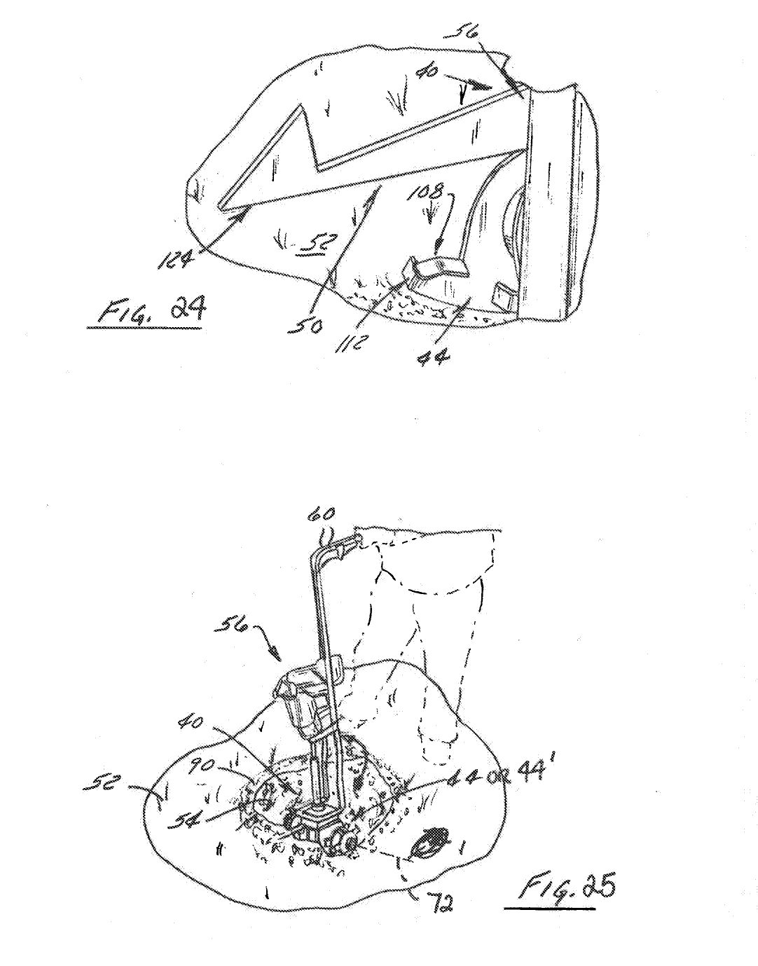

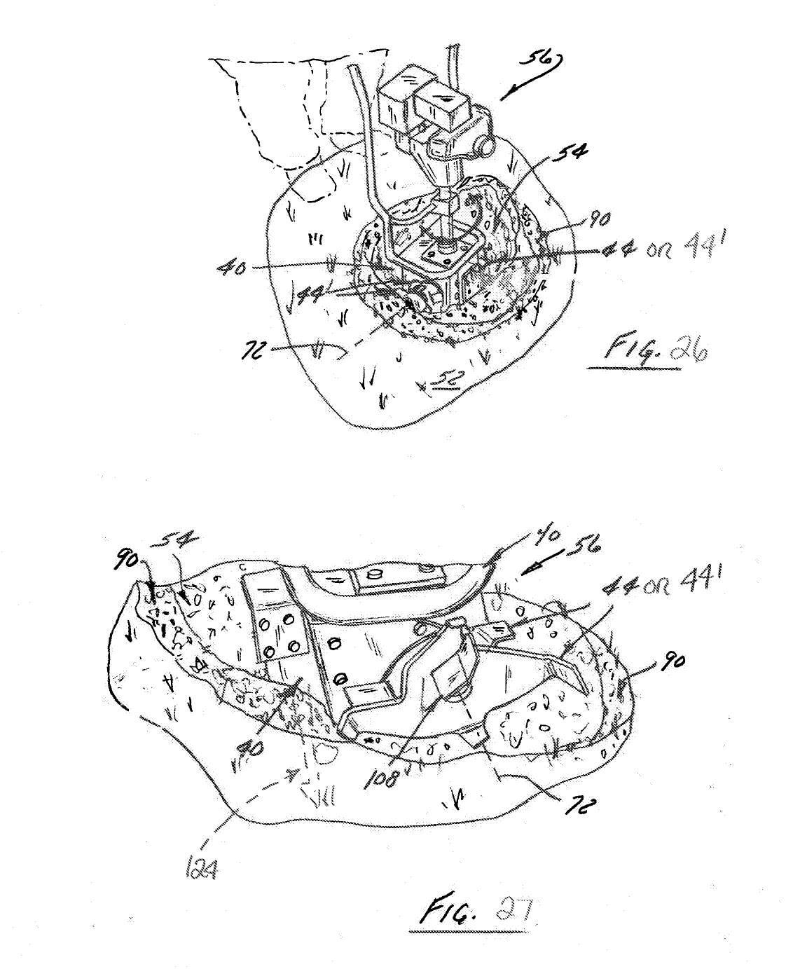

In use, as seen in FIG. 23, the mini tiller 56 is maneuvered to a location of the ground 52 where it is desired to dig a hole 54 in the ground 52. The stake 124 of the hole digger anchor 50 is extended outwardly to a depth greater than the depth of the tines 44 and/or 44′ and inserted into the ground 52 at approximately a center point of where the hole 54 is desired to be dug. While the tines 44 and/or 44′ can be rotating prior to stake insertion, in one method of digging a hole, the tines 44 and/or 44′ are not rotated until after the stake 124 is inserted into the ground 52. As the tines 44 and/or 44′ initiate rotation after the stake 124 has been inserted into the ground, the tine arms 108 engage the ground 52 breaking the ground up and flinging ground matter 90 away from the tines 44 and/or 44′. Continued tine rotation causes more and more ground matter 90 to be displaced from where the tines 44 and/or 44′ engage the ground 52 with the tines 44 and/or 44′ throwing the broken up matter 90 onto the outer surface of the ground 52 not engaged by the tines 44 surrounding the area where the hole 54 is being dug. In a preferred embodiment, the mini tiller 56 is equipped with a pair of hole digging tine sets 42′ each having at least one hole digger tines 44′ equipped with a deflector 112 generally transversely angled relative to the plane of rotation of the tines 44′.

In one preferred method of digging a hole, the tines 44 and/or 44′ are rotated in a direction where each tine arm 108 enters the ground at or adjacent a front of the mini tiller 56 and exits the ground at or adjacent a rear of the tiller 56 depositing the broken up or loose ground matter 90 adjacent a user (such as shown in FIG. 25) operating the tiller 56. If desired, the tines 44 and/or 44′ can be rotated in an opposite direction. In a preferred embodiment, the mini tiller 56 is equipped with a pair of hole digging tine sets 42′ each having at least one hole digger tines 44′ equipped with a deflector 112 generally transversely angled relative to the plane of rotation of the tines 44′.

As is best shown in FIG. 25, a user grasping the handles 60 of the tiller 56 pivots the tines 44 and/or 44′ about the anchor stake 124 anchoring the tiller 56 so that the rotating tines 44 and/or 44′ will propel ground matter 90 broken up by the tines along an annular region of the hole 54 being dug that extends around the anchor stake 124. To the extent that the rotating tines 44 and/or 44′ cause the tiller 56 to forwardly “walk” as it would ordinarily do during tilling or cultivating, the tiller 56 does so about the anchor stake 124 with the anchor stake 124 serving as a pivot axis about which the tiller 56 can circular travel during hole digging. The tapered end of the stake 124 advantageously helps the stake 124 to continue driving downward into deeper and deeper ground as the rotating tines 44 and/or 44′ dig the hole 54 by displacing ground matter 90 on the outer undisturbed surface of the ground 52 adjacent to and surrounding the hole 54. As the tiller 56 is pivoted about the anchor stake 124, the tines 44 and/or 44′ continue to engage, displace, and propel broken up or loose ground matter 90 outwardly of the hole 54 onto the outer surface of the ground 52 surrounding the hole 54.

As is shown by FIGS. 22-28, a tiller 56 configured as a hole digger 40 operating as a hole digger 40 advantageously breaks up ground matter 90 in the hole 54 into relatively loose dirt and smaller chunks of material, e.g., sod and the like, propelled out of the hole 54 that can easily be scooped up and removed as well as pushed back into the hole 54 after planting of a shrub, tree, plant, or insertion of a post in the hole 54. In one preferred hole digging method, at least one tine set 42′ on each side of the tiller 56 are of hole digging tine construction having at least one tine 44′ are configured with axially and radially extending deflectors 112 alongside each hole digger tine 44′ increasing the rate of volume of ground matter 90 displaced from the hole 54 during hole digging. In another preferred hole digging method where the tiller 56 has a plurality of tine sets on either side, at least the outer tine set on each side is a hole digging tine set 42′ having at least one hole digger tine 44′ equipped with one or more deflectors 112.

As previously discussed, the tiller 56 can be pivoted back and forth about the stake 124 enough times so that the tines 44 and/or 44′ are able to remove broken up and loose ground matter 90 from the hole 54 and deposit it substantially completely about the circumference of the hole 54 being dug so as to produce a generally round or oblong hole 54 having a depth of at least 4 inches or more, such as depicted by the leg of the user standing in the hole shown in FIG. 28. In another preferred method of digging a hole, a generally round or oblong hole 54 is produced having a depth of at least 6 inches. In a still further preferred method of digging a hole 54, hole depth is at least 8 inches.

It is also to be understood that, although the foregoing description and drawings describe and illustrate in detail one or more preferred embodiments of the present invention, to those skilled in the art to which the present invention relates, the present disclosure and numbered claims below will suggest many modifications and constructions as well as widely differing embodiments and applications without thereby departing from the spirit and scope of the invention.

What is claimed is:

1. A hole digger having a set of rotary tines rotatable about an axis of rotation and a downwardly extending hole digger anchor that engages the ground below the rotary tines causing the tines to rotate in place about the hole digger anchor digging a hole.

2. The hole digger of claim 1 wherein the hole digger anchor defines a pivot about which the rotary tines pivot in digging a circular hole.

3. The hole digger of any one of claim 1 or 2 wherein the hole digger anchor comprises an elongate anchor stake that stops the hole digger from walking or crabbing in a generally horizontal direction along the ground relative to the rotational axis of the tines.

4. The hole digger of any one of claims 1-3 wherein the hole digger anchor is disposed interjacent a plurality of sets of tines.

5. The hole digger of any one of claims 1-4 wherein the hole digger anchor is disposed within a circumference defined by a generally downwardly extending central axis bisecting a rotary shaft carrying the tines generally transverse to the rotational axis of the tines.

6. The hole digger of any one of claims 1-5 wherein the hole digger anchor is mounted to a transmission of the hole digger that communicates rotary power from a prime mover to the rotary tines.

7. The hole digger of any one of claims 1-6 wherein the hole digger anchor has a necked down portion adjacent its free end.

8. The hole digger of any one of claims 1-7 wherein the hole digger anchor comprises a hook having a barb generally perpendicular to a stem of the digger anchor.

9. The hole digger of any one of claims 1-8 wherein the hole digger anchor comprises a hook having a barb generally transverse to the rotational axis of the tines.

10. The hole digger of any one of claims 1-9 wherein the hole digger anchor comprises a hook having a barb facing in a direction opposite a generally horizontal walking or crabbing force generated by the rotary tines during tine rotation.

11. The hole digger of any one of claims 1-10 wherein the hole digger anchor comprises a mounting assembly having one portion extending along one side of a hole digger transmission and another portion extending along an opposite side of the hole digger transmission.

12. The hole digger of any one of claims 1-11 wherein the hole digger anchor comprises a position adjustable hole digger anchor stake.

13. The hole digger of any one of claims 1-12 wherein the hole digger anchor comprises a position adjustable hole digger anchor stake that is adjustable between an extended hole digger anchoring position that stops crabbing or walking movement caused by tine rotation and a retracted position permitting use of the hole digger as a tiller.

14. The hole digger of any one of claims 1-13 wherein the hole digger anchor comprises a hole digger mounting assembly enabling removal of one of a hole digger anchor stake and a hole digger mounting bracket from the hole digger enabling use of the hole digger as a tiller.

15. The hole digger of any one of claims 1-14 wherein the hole digger comprises a tiller or cultivator.

16. The hole digger of any one of claims 1-15 wherein the hole digger comprises a mini tiller.

17. The hole digger of any one of claims 1-16 wherein the hole digger comprises a tiller or cultivator lacking any wheels and lacking any drag stake or depth indicator.

18. The hole digger of any one of claims 1-17 wherein at least one rotary tine comprises at least one axially and radially extending scoop.

19. The hole digger of any one of claims 1-18 wherein a plurality of sets of rotary tines comprises a plurality of axially and radially extending scoops adjacent a corresponding one of a plurality of tine arms with one of the sets of rotary tines disposed on one side of the hole digger anchor stake and another one of the sets of rotary tines disposed on an opposite side of the hole digger anchor stake.

20. The hole digger of any one of claims 1-19 wherein the hole digger comprises an elongate hole digger anchor stake having a length such that digger anchor stake extends to a depth that is at least 25% greater than a largest tine radius of the plurality of rotary tines.

21. The hole digger of any one of claims 1-20 wherein the hole digger comprises an elongate hole digger anchor stake having a length such that digger anchor stake extends to a depth that is at least 25% greater than the depth of a rotary tine of the plurality of rotary tines rotating in the ground in digging a hole.

22. The hole digger of any one of claims 1-21 wherein the hole digger comprises an elongate hole digger anchor stake that is oriented with a longitudinally extending axis of the hole anchor digger stake extending downwardly generally transverse to the rotational axis of the tines and generally parallel to a powerhead shaft axis comprising a rotational axis of an output shaft of a prime mover rotating the rotary tines.

23. A tiller or cultivator having a set of rotary tines rotatable about an axis of rotation and a downwardly extending hole digger anchor that engages the ground below the rotary tines causing the tines to rotate in place about the hole digger anchor digging a hole.

24. The tiller or cultivator of claim 23 wherein the hole digger anchor defines a pivot about which the rotary tines pivot in digging a hole.

25. The tiller or cultivator of any one of claim 23 or 24 wherein the hole digger anchor comprises an elongate anchor stake that stops the tiller from walking or crabbing in a generally horizontal direction along the ground relative to the rotational axis of the tines.

26. The tiller or cultivator of any one of claims 23-25 wherein the hole digger anchor is disposed interjacent a plurality of sets of the tines.

27. The tiller or cultivator of any one of claims 23-26 wherein the hole digger anchor is disposed within a circumference defined by a generally downwardly extending central axis bisecting a rotary shaft carrying the tines generally transverse to the rotational axis of the tines.

28. The tiller or cultivator of any one of claims 23-27 wherein the hole digger anchor is mounted to a transmission of the tiller that communicates rotary power from a prime mover to the rotary tines.

29. The tiller or cultivator of any one of claims 23-28 wherein the hole digger anchor has a necked down portion adjacent its free end.

30. The tiller or cultivator of any one of claims 23-29 wherein the hole digger anchor comprises a hook having a barb generally perpendicular to a stem of the digger anchor.

31. The tiller or cultivator of any one of claims 23-30 wherein the hole digger anchor comprises a hook having a barb generally transverse to the rotational axis of the tines.

32. The tiller or cultivator of any one of claims 23-31 wherein the hole digger anchor comprises a hook having a barb facing in a direction opposite a generally horizontal walking or crabbing force generated by the rotary tines during tine rotation.

33. The tiller or cultivator of any one of claims 23-32 wherein the hole digger anchor comprises a mounting assembly having one portion extending along one side of a tiller transmission and another portion extending along an opposite side of the tiller transmission.

34. The tiller or cultivator of any one of claims 23-33 wherein the hole digger anchor comprises a position adjustable hole digger anchor stake.

35. The tiller or cultivator of any one of claims 23-34 wherein the hole digger anchor comprises a position adjustable hole digger anchor stake that is adjustable between an extended hole digger anchoring position that stops crabbing or walking movement caused by tine rotation enabling use of the tiller as a hole digger and a retracted position permitting use of the tiller to till soil.

36. The tiller or cultivator of any one of claims 23-35 wherein the hole digger anchor comprises a hole digger mounting assembly enabling removal of one of a hole digger anchor stake and a hole digger mounting bracket from the tiller enabling use of the tiller to till soil when removed.

37. The tiller or cultivator of any one of claims 23-36 wherein at least one rotary tine comprises at least one axially and radially extending scoop.

38. The tiller or cultivator of any one of claims 23-37 wherein a plurality of sets of rotary tines comprises a plurality of axially and radially extending scoops adjacent a corresponding one of a plurality of tine arms with one of the sets of rotary tines disposed on one side of the hole digger anchor stake and another one of the sets of rotary tines disposed on an opposite side of the hole digger anchor stake.

39. The tiller or cultivator of any one of claims 23-38 wherein the tiller comprises an elongate hole digger anchor stake having a length such that digger anchor stake extends to a depth that is at least 25% greater than a largest tine radius of the plurality of rotary tines.

40. The tiller or cultivator of any one of claims 23-39 wherein the tiller comprises an elongate hole digger anchor stake having a length such that digger anchor stake extends to a depth that is at least 25% greater than the depth of a rotary tine of the plurality of rotary tines rotating in the ground in digging a hole.

41. The tiller or cultivator of any one of claims 23-40 wherein the tiller comprises an elongate hole digger anchor stake that is oriented with a longitudinally extending axis of the hole anchor digger stake extending downwardly generally transverse to the rotational axis of the tines and generally parallel to a powerhead shaft axis comprising a rotational axis of an output shaft of a prime mover rotating the rotary tines.

42. The tiller or cultivator of any one of claims 23-41 wherein the tiller comprises a mini tiller.

43. The tiller or cultivator of any one of claims 23-42 wherein the tiller comprises a tiller lacking any wheels and lacking any drag stake or depth indicator during hole digging.

44. A method of digging a hole in the ground comprising:
(a) providing a hole digging apparatus with a plurality of rotary tines driven by a prime mover and an elongate hole digger anchor stake projecting to a depth in the ground during hole digging operation greater than the depth of the rotary tines;
(b) inserting the hole digger anchor stake into the ground; and
(c) rotating the tines to dig a hole.

45. The hole digging method of claim 44 comprising the further step of pivoting the rotating tines about the hole digger anchor stake during step (c).

46. The hole digging method of claim 44 or 45 wherein the hole digger anchor stake stops horizontal movement of the rotary tines during tine rotation during step (c).

47. The hole digging method of any one of claims 44-46 wherein a plurality of the tines have an outwardly extending scoop carried thereby.

48. The hole digging method of any one of claims 44-47 wherein a hole having a depth of at least four inches is produced.

49. The hole digging method of any one of claims 44-48 wherein a generally round hole is produced.

50. The hole digging method of any one of claims 44-49 wherein the hole digging apparatus comprises a roto tiller or cultivator.

51. The hole digging method of any one of claims 44-50 wherein the hole digging apparatus comprises a mini tiller.
